(19) United States
(12) Patent Application Publication
(10) Pub. No.: US 2004/0254674 A1
(43) Pub. Date: Dec. 16, 2004

(54) Work transfer method and system

(76) Inventors: Satoshi Nojo, Tochigi-ken (JP); Satoshi Kanbayashi, Tochigi-ken (JP); Riko Inoue, Tochigi-ken (JP); Tetsuya Okajima, Tochigi-ken (JP); Tetsuharu Komatsu, Tochigi-ken (JP)

Correspondence Address: BIRCH STEWART KOLASCH & BIRCH, PO BOX 747, FALLS CHURCH, VA, 22040-0747, US

(21) Appl. No.: 10/484,615

(22) PCT Filed: Jul. 24, 2002
(86) PCT No.: PCT/JP02/07474

(30) Foreign Application Priority Data
Jul. 24, 2001 (JP) 2001-223502
Jul. 24, 2001 (JP) 2001-223506
Jul. 24, 2001 (JP) 2001-223515
Jul. 24, 2001 (JP) 2001-223458
Jul. 24, 2001 (JP) 2001-223475
May 20, 2002 (JP) 2002-145041
May 20, 2002 (JP) 2002-145232

(51) Int. Cl. G06F 17/60

(52) U.S. Cl. 700/213; 705/1; 700/112

(57) ABSTRACT

A movement range assigned to each transportation vehicle 18 is determined and input (step S1). Then, on the assumption that one transportation vehicle 18 fails, movement ranges assigned to remaining transportation vehicles 18 are determined and input (step S2). Thereafter, a main controller 12 determines the state of each transportation vehicle 18 (step S3). If each transportation vehicle 18 is normal, the movement range determined in step S1 is applied (step S4). If any one of the transportation vehicles 18 is abnormal, the movement range determined in step S2 is applied. Then, an unloading source and a loading destination for the transportation vehicle 18 are determined (step S6). After transportation paths for the transportation vehicle 18 are searched for (step S7), path candidates that have been searched for and determined are enumerated (step S8). The transportation paths are corrected to obtain reasonable transportation paths (step S9), and transportation times of the respective path candidates are calculated (step S10). Then, a transportation path with the shortest transportation time is selected, and branching devices 22 are reserved to avoid conflicts with other transportation vehicles upon movement of the transportation vehicle 18 along the determined transportation path (step S11).

### TECHNICAL FIELD

The present invention relates to a method of and a system for transporting workpieces, and more particularly to a method of and a system for transporting workpieces efficiently in a network of transportation paths, relay paths, and stations.

1. Background Art

Factories can utilize their space more efficiently if their processing machines are installed at desired positions rather than placed in a line.

A network of transportation paths is provided between the machines tools, and a transportation vehicle transports workpieces along transportation paths.

Generally, a plurality of transportation vehicles move along the transportation paths which are memorized in the vehicles or indicated by a controller.

According to the conventional art, there have not been established any measures between processing machines and transportation vehicles in view of the transportation efficiency as to which transportation vehicles should load workpieces to and unload workpieces from which processing machines. Specifically, at the time an unloading request or a loading request is transmitted from a processing machine, an idle transportation vehicle near that processing machine takes charge of loading or unloading a workpiece, or a single transportation vehicle is assigned for each process.

According to the method in which an idle transportation vehicle near the processing machine takes charge of loading or unloading a workpiece, even when there is a processing machine that is ready for unloading a workpiece therefrom, if there is no transportation vehicle near that processing machine, the processing machine has to wait for a relatively long period of time until a transportation vehicle arrives at the processing machine. Even if there is an idle transportation vehicle near the processing machine, a conflicting state, i.e., a so-called deadlock, frequently occurs in which other transportation vehicles in service simultaneously share transportation paths and branch paths with the idle transportation vehicle.

According to the latter method in which a single transportation vehicle is assigned for each process, if the transporting capability of the transportation vehicle is lower than the processing capability of the process, then the operating efficiency of the processing machine in the process is lowered, resulting in a reduction in the production capability of the factory. Conversely, if the transporting capability of the transportation vehicle is much greater than the processing capability of the process, then the ability of the transportation vehicle is overkill and not preferable from the standpoint of efforts to increase the operating efficiency of the transportation vehicle.

Another conventional process of transporting workpieces through a network of transportation paths is disclosed in Japanese laid-open patent publication No. 5-225170, for example. According to the disclosed conventional process, evaluated values of paths for transporting workpieces are determined based on a predetermined evaluating reference, and it is judged whether paths are appropriate or not based on the evaluated values. However, the operating efficiency of processing machines is not taken into account.

A workpiece transportation system viewed as a whole should desirably of a flexible system arrangement that allows the system to continue its operation in the event of a failure of some parts of the system such as transportation vehicles. The period of time that is taken until the system is turned into a temporary production setup after the occurrence of a failure should preferably be as short as possible. The temporary production setup should preferably maintain a certain level of production efficiency though the production efficiency may inevitably suffer a reduction.

The conventional transportation system is also disadvantageous in that it is highly complex to control the movement of transportation vehicles. Specifically, if an error is developed between a period of time that is consumed by each processing machine to process a workpiece and an expected processing time thereof, or if a sudden plan change or a processing machine failure occurs, then the scheme to move transportation vehicles needs to be set up again each time such a situation occurs. If the above situation occurs frequently, the processor of the system undergoes a large calculation burden. While the processor is performing calculations, the transportation vehicles need to be stopped, resulting in a poor efficiency.

According to the conventional art, there have not been established any means and methods for each transportation vehicle to appropriately select a path along which to move in the network of transportation paths.

Specifically, the number of paths available from a start point to an end point is enormous, and even a computer takes a long period of time to select a single path from those paths while excluding backward, roundabout, and repetitive paths from consideration. During that long period of time, the transportation vehicles and the processing machines are in a standby mode, thus limiting the operation efficiency of the factory.

In view of the prevention of collisions with other transportation vehicles on paths, it is necessary to provide a suitable number of path candidates. However, there has not been established a method of selecting and determining appropriate paths.

According to the conventional art, even if a path along which to move a transportation vehicle is selected by a certain algorithm, it is not sufficiently checked as to whether the selected path is a shortest path or not.

Specifically, if transportation paths that are applied are in a grid-like pattern of horizontal rows and vertical columns or in a pattern of transportation paths neatly arranged according to rules, then a reasonable path is expected to be selected according to a certain algorithm. However, there is no way of confirming whether a selected path is reasonable or not if the path has been selected from an irregular pattern of transportation paths. While the human being is capable of easily recognizing the rationality of paths on a map, it is difficult for the computer to determine the rationality of paths using tables and data series in a memory. As a result, when a transportation path moves along a path whose rationality has not been checked, the transportation path may move a roundabout way.

Even if transportation paths are provided in a grid-like pattern, the system tends to suffer the same problem as described above when some of the transportation paths are down for maintenance or other reasons.

According to the conventional art, there has not been established a suitable method of determining which path of movement paths should be taken to reach an end point within a shortest period of time.

Specifically, even if possible paths are narrowed down to certain paths, in view of conflicts with other transportation paths on the paths, a geometrically shortest path may not necessarily result in a shortest period of time, but a roundabout path may be faster taking account of the need for waiting for other transportation vehicle to pass by. However, there has not been established a suitable selective method of determining which one of path candidates is to be selected.

According to the conventional art, when a plurality of transportation units move along a transportation path, some movement control is required to avoid the deadlock referred to above.

In order to eliminate the above drawbacks, there are available a process of calculating, in advance, all paths and times that transportation vehicles move along and in with respect all processes, and a process of avoiding conflicts by controlling transportation vehicles to travel in one-way traffic.

However, the process involving advance calculations not only needs a vast amount of processing operation and a long processing time, but also finds it difficult to handle abrupt plans. In addition, a memory for recording calculated results is required to be highly reliable.

According to the process of controlling transportation vehicles to travel in one-way traffic, transportation units have to move a long distance for a long period of time, the degree of freedom of path selections is low, and it may be difficult to add transportation paths.

### DISCLOSURE OF THE INVENTION

The present invention has been made in view of the above difficulties. It is an object of the present invention to provide a method of and a system for transporting workpieces while allowing a plurality of transportation units and a plurality of stations to operate efficiently on a network of transportation paths.

Another object of the present invention is to provide a method of and a system for transporting workpieces while increasing the operating efficiency of both stations such as processing machines and transportation vehicles and lowering the frequency of conflicts between transportation vehicles.

Still another object of the present invention is to provide a method of and a system for transporting workpieces in a workpiece transportation system which transports workpieces using a plurality of transportation units between stations assigned to respective processes, allowing the workpiece transportation system to shift quickly to a succeeding setup when the transportation units stop their operation.

Yet another object of the present invention is to provide a method of and a system for transporting workpieces while assigning suitable transportation vehicles depending on the state of transportation paths along which to move transportation vehicles in a network of transportation paths.

Yet still another object of the present invention is to provide a method of and a system for transporting workpieces while effectively eliminating useless paths from combinations of all transportation paths along which to move transportation vehicles in a network of transportation paths, and minimizing the frequency with which to select backward paths, the frequency with which to select roundabout paths, and the frequency with which to select repetitive paths from the network of transportation paths.

A further object of the present invention is to provide a method of and a system for transporting workpieces while judging the rationality of a path from a start point to an end point and replacing an unreasonable roundabout path with a shorter path in a network of transportation paths and relay paths to which the transportation paths are connected.

A still further object of the present invention is to provide a method of and a system for transporting workpieces while allowing a transportation vehicle to reach an end point in a short period of time in view of the movement of other transportation vehicles on transportation paths along which to move transportation vehicles in a network of transportation paths.

A yet still further object of the present invention is to provide a method of and a system for transporting workpieces while setting up a path free of a conflict of transportation vehicles depending on the state of other transportation units, among transportation paths along which to move transportation vehicles in a network of transportation paths.

According to the present invention, there is provided a method of transporting workpieces using a plurality of transportation units for transporting workpieces, a plurality of stations into which said workpieces can be loaded from said transportation units and from which said workpieces can be unloaded to said transportation units, a plurality of transportation paths for moving said transportation units therealong and stopping said transportation units thereon, relay paths disposed at relay points between two or more of said transportation paths, for receiving said transportation units which have entered and stopped from one of said transportation paths and sending said transportation units to enter into another one of said transportation paths, and a control unit for controlling operation of said transportation units, said transportation paths, said stations, and said relay paths, said method comprising the first, second, third, and fourth steps of determining areas assigned to said transportation units, respectively, determining a loading source and an unloading source for each of said transportation units, enumerating path candidates determined by searching for transportation paths for each of said transportation units, and calculating transportation times for the path candidates, respectively, and selecting a path having the shortest transportation time based on operating conditions of the transportation units, wherein said workpieces are loaded into and unloaded from said stations by said transportation units.

The method may further comprise the steps of determining a frequency with which to load said workpieces into and unload said workpieces from each of said stations, and dividing said stations into a plurality of areas so that the sums of the frequencies are in substantial conformity with each other, and assigning a constant number of said transportation units to each of said areas, wherein each of said transportation units loads said workpieces into and unloads said workpieces from said stations in the area assigned to said transportation units.

With the above method, it is possible to increase the operating efficiencies of both the stations and the transportation units and lower the frequency with which the transportation units will conflict with each other.

The first step may comprise the steps of determining a frequency with which to load said workpieces into and unload said workpieces from each of said stations, dividing said stations into a plurality of basic areas so that the sums of the frequencies are in substantial conformity with each other, assigning one of said transportation units to each of said basic areas, and storing information of said basic areas, assuming that one of said transportation units cannot be used, providing a combined area including the basic area assigned to the unusable transportation unit and basic areas adjacent to said basic area, dividing said stations in said combined area into provisional areas so that the sums of the frequencies are in substantial conformity with each other, assigning one of said transportation units to each of said provisional areas, and storing information of said provisional areas, loading said workpieces into and unloading said workpieces from said stations in said basic areas to which said transportation units are assigned, while detecting states of said transportation units, and when one of said transportation units cannot be used, replacing a combined area preset for the unusable transportation unit with said provisional area.

Since it is assumed that one of the transportation units cannot be used and provisional areas capable of making up for basic areas assigned to the unusable transportation unit are established in advance, when one of the transportation units actually stops operating, the system can quickly be shifted into a mode in which it can continuously operate.

The step of determining a frequency may comprise the step of determining an actual frequency with which to load or unload said workpieces, including a standby time in which said station waits for processing.

The stations may serve to process said workpieces and may be classified into a plurality of processes in order, and said step of determining a frequency may comprise the step of determining the frequency from a process assigning ratio in said processes.

The stations may serve to process said workpieces and may be classified into a plurality of processes in order, and said method may further comprise the steps of determining one of said processes which has a slowest average workpiece processing time, and temporarily executing said transportation units and said stations and checking an operating efficiency of said determined process having the slowest average workpiece processing time, wherein if said operating efficiency is not 100%, conditions may be changed, and said step of dividing said stations into a plurality of areas so that the sums of the frequencies are in substantial conformity with each other, and assigning a constant number of said transportation units to each of said areas may be carried out again.

The provisional areas may be changed back to said basic areas when said unusable transportation unit is restored so as to be usable.

The second step may comprise the steps of storing a loading request signal from said stations, storing an unloading request signal from said stations, and updating an operation plan of said transportation units based on said loading request signal and said unloading request signal.

The step of updating an operation plan may be executed when said control unit receives said loading request signal or said unloading request signal, or one of said transportation units becomes idle.

With the above arrangements, an appropriate operation plan depending on the states of the transportation units, the transportation paths, the stations, and the relay paths may be determined each time the states are changed.

The step of storing a loading request signal and said step of storing an unloading request signal may store said loading request signal and said unloading request signal in a chronological sequence.

The method may further comprise the step of assigning said transportation units which load or unload said workpieces to said stations, wherein said step of updating an operation plan is executed when a transportation unit assigned to a station which has sent said loading request signal is determined and said determined transportation unit is judged as being idle from said operation plan.

The method may further comprise the steps of, when said transportation units are transported along the path selected in said fourth step, recording reservation information for each of said transportation paths or said relay paths, indicating that said transportation units use said transportation path or said relay path, and preventing the transportation path or said relay path for which said reservation information is recorded, from being used by other transportation units based on contents of said reservation information.

In this manner, the transportation units are prevented from conflicting with each other.

The reservation information may include place information and time information representing, respectively, the places in order and times of the transportation units which use said transportation path or said relay path.

The reservation information may be recorded as being divided into an entry reservation for the transportation units to enter into said transportation path or said relay path, and a traveling reservation for the transportation units to leave said transportation path or said relay path.

The record of said reservation information may be deleted when the transportation units end using said transportation path or said relay path for which said reservation information has been recorded.

The third step may comprise the steps of stipulating a reference vector extending from a start point to a goal point on a network of transportation paths and relay paths to which the transportation paths are connected, and selecting one of the transportation paths which is present in a predetermined angular range from said reference vector and includes said start point, as a movement path.

With the above arrangements, it is possible to effectively eliminate useless paths from combinations of all transportation paths, and to minimize the frequency with which to select backward paths. The frequency with which to select roundabout paths, and the frequency with which to select repetitive paths are greatly reduced.

In the step of selecting one of the transportation paths which is present in a predetermined angular range from said reference vector and includes said start point, as a movement path, if no transportation path is present within said predetermined angular range, then a transportation path having a smallest angle with respect to said reference vector may be selected as a movement path. The predetermined angular range may be ±90°.

The method may further comprise the steps of stipulating one of the relay paths remoter from said start point, as a next start point, the relay paths being connected to the transportation path selected as the movement path, and stipulating a reference vector extending from a start point to a goal point on a network of transportation paths and relay paths to which the transportation paths are connected, selecting one of the transportation paths which is present in a predetermined angular range from said reference vector and includes said start point, as a movement path, and repeating said steps of stipulating one of the relay paths and selecting one of the transportation paths.

If said start point or said goal point is a midway point on said transportation path, then said start point or said goal point may be replaced with a relay path connected to said transportation path.

The third step may comprise the steps of storing a path candidate from a start point to a goal point as a string of relay paths on a network of paths, selecting one of the relay paths stored as said path candidate, as a selected relay path, stipulating a reference vector extending from said start point to said selected relay path, searching for a transportation path which is present in a predetermined angular range from said reference vector and includes said start point, as a corrective transportation path, establishing a partial corrective path leading to said selected relay path, with a relay path connected to said corrective transportation path being established next to said start point, and storing a path including said partial corrective path in part or entirety and leading to said goal point, as a corrective path.

In this manner, the paths stored as a string of relay paths may be searched based on reference vectors from the start point to each of the relay paths, and partial corrective paths may be determined from the positional relationship between the start point and each of the relay paths. Original paths may be corrected using the partial corrective paths.

The step of storing a corrective path may store a path having a portion of said path candidate which extends from said selected relay path to said goal point and is added to a latter part of said partial corrective path in part or entirety, as the corrective path.

When a plurality of path candidates are stored, a path candidate with said selected relay path being stored in a smallest place in order or a path candidate having a shortest length may be selected as a selected path candidate, and said step of storing a path including said partial corrective path in part or entirety and leading to said goal point, as a corrective path, may be carried out only when the place in order of said selected relay path in said selected path candidate is greater than the place in order of said selected relay path in said partial corrective path.

The fourth step may comprise the steps of storing a path extending from a start point to a goal point on a network of transportation paths and relay paths to which the transportation paths are connected, as a string of said transportation paths and/or said relay paths, and determining a passage time required for said transportation units to pass through said transportation paths and said relay paths, determining a standby time in which said transportation units wait on said transportation paths and said relay paths, and totaling said passage time and said standby time to calculate a transportation time over said path.

In this fashion, a transportation time over the movement path of a transportation unit on the network can be calculated taking into account the movement of other transportation units.

A reservation time for each of transportation paths and/or said relay paths and an arrival time at which said transportation units arrive at said transportation paths and/or said relay paths may be compared with each other, and if said reservation time is greater than said arrival time, the difference therebetween may be used as said standby time, and if said reservation time is smaller than said arrival time, said standby time may be set to 0.

According to the present invention, there is also provided a system for transporting workpieces, comprising a plurality of transportation units for transporting workpieces, a plurality of transportation paths for moving said transportation units therealong and stopping said transportation units thereon, a plurality of stations into which said workpieces can be loaded from said transportation units and from which said workpieces can be unloaded to said transportation units, relay paths disposed at relay points between two or more of said transportation paths, for receiving said transportation units which have entered and stopped from one of said transportation paths and sending said transportation units to enter into another one of said transportation paths, and a control unit for controlling operation of said transportation units, said transportation paths, said stations, and said relay paths.

The system may further comprise a request memory unit for storing a loading request signal from said stations and an unloading request signal from said stations, and an operation plan updating unit for updating operation plans of said transportation units based on said loading request signal and said unloading request signal.

The control unit may record reservation information for each of said transportation paths or said relay paths, indicating that said transportation units use said transportation path or said relay path, and prevents the transportation path or said relay path for which said reservation information is recorded, from being used by other transportation units based on contents of said reservation information.

The system may further comprise a vector stipulating unit for stipulating a reference vector from a start point to an end point on a network of said transportation paths and said relay paths, and an angular range path selecting unit for selecting one of the transportation paths which is present in a predetermined angular range from said reference vector and includes said start point, as a movement path.

The system may further comprise a passage time calculating unit for storing a path extending from a start point to a goal point on a network of said transportation paths and said relay paths, as a string of said transportation paths and/or said relay paths, and determining a passage time required for said transportation units to pass through said transportation paths and said relay paths, a standby time calculating unit for determining a standby time in which said transportation units wait on said transportation paths and said relay paths, and a transportation time totaling unit for totaling said passage time and said standby time for the string of said transportation paths and/or said relay paths, to calculate a transportation time over said path.

### BRIEF DESCRIPTION OF THE DRAWINGS

FIG. 1 is a perspective view, partly omitted from illustration, of a workpiece transportation system according to an embodiment of the present invention;

FIG. 2 is a diagram showing a network of transportation paths divided into basic areas, temporary areas, and a combined area;

FIG. 3 is a perspective view of a mounting/dismounting device and a transportation vehicle;

FIG. 4 is an elevational view of a branching device;

FIG. 5 is a functional block diagram of the workpiece transportation system according to the embodiment of the present invention;

FIG. 6 is a flowchart of an operation sequence of a workpiece transportation method according to the embodiment of the present invention;

FIG. 7 is a flowchart of an operation sequence of setting up basic areas;

FIG. 8 is a diagram showing a first example of a frequency calculating table for determining loading/unloading frequency proportions;

FIG. 9 is a diagram showing a second example of a frequency calculating table for determining loading/unloading frequency proportions;

FIG. 10 is a diagram showing a network of transportation paths divided into three basic areas;

FIG. 11 is a diagram showing an area information table recording therein basic areas and temporary areas that are set up for respective mounting/dismounting devices;

FIG. 12 is a flowchart of an operation sequence of setting up temporary areas on the assumption that each transportation vehicle stops its operation;

FIG. 13 is a diagram showing a network of transportation paths divided into three basic areas in a modification of a method of determining movement ranges assigned to transportation vehicles;

FIG. 14 is a diagram showing a frequency calculating table for determining loading/unloading frequency proportions in the modification of the method of determining movement ranges assigned to transportation vehicles;

FIG. 15 is a flowchart of an operation sequence of setting up temporary areas on the assumption that each transportation vehicle stops its operation;

FIG. 16A is a diagram showing contents of a loading request data table;

FIG. 16B is a diagram showing contents of an unloading request data table;

FIG. 17 is a diagram showing contents of an operation plan table recording therein the operation states of respective transportation vehicles;

FIG. 18A is a diagram showing contents of a first workpiece type table;

FIG. 18B is a diagram showing contents of a second workpiece type table;

FIG. 19 is a flowchart of an operation sequence of determining an unloading source and a loading destination of a transportation vehicle;

FIG. 20 is a diagram showing a network of transportation paths set to a single common area in the modification of the method of determining movement ranges assigned to transportation vehicles;

FIG. 21 is a diagram showing contents of a branching device passage information table;

FIG. 22 is a diagram showing contents of a branching device information table;

FIG. 23 is a diagram showing contents of a path candidate data table;

FIG. 24 is a flowchart (No. 1) of an operation sequence of searching for a transportation path for a transportation vehicle;

FIG. 25 is a flowchart (No. 2) of the operation sequence of searching for a transportation path for a transportation vehicle;

FIG. 26 is a diagram showing the function of an angular range path selector;

FIG. 27 is a diagram showing angles (θa, θb) with respect to two connection destinations;

FIG. 28 is a diagram showing a conceptual representation of information of a branching device passage information table;

FIG. 29 is a flowchart of an operation sequence of enumerating path candidates;

FIG. 30 is a diagram showing a process of generating a path candidate data table in step S602;

FIG. 31 is a diagram showing a process of generating a path candidate data table in steps S605 and S606;

FIG. 32 is a diagram showing a reference vector as applied to a three-dimensional transportation path;

FIG. 33 is a diagram of a network of transportation paths to which an operation sequence of correcting path candidates is applied;

FIG. 34 is a diagram showing contents of a branching device passage information table recording therein information of corrected paths which are provided by correcting path candidates;

FIG. 35 is a diagram showing contents of a path candidate data table recording therein corrected paths which are provided by correcting path candidates;

FIG. 36 is a flowchart of an operation sequence of correcting path candidates;

FIG. 37 is a diagram showing contents of a corrected path candidate data table;

FIG. 38 is a diagram showing contents of a transportation path information table;

FIG. 39 is a diagram showing contents of a path candidate data table;

FIG. 40 is a diagram showing contents of a path candidate time data table which is being calculated;

FIG. 41 is a diagram showing contents of a branching device reservation data table;

FIG. 42 is a diagram showing contents of a branching device time management table;

FIG. 43 is a flowchart (No. 1) of an operation sequence of calculating transportation times of respective path candidates and selecting the shortest transportation time;

FIG. 44 is a flowchart (No. 2) of the operation sequence of calculating transportation times of respective path candidates and selecting the shortest transportation time;

FIG. 45 is a flowchart of an operation sequence of reserving branching devices according to paths;

FIG. 46 is a diagram showing contents of the branching device reservation data table which is being generated;

FIG. 47 is a diagram showing contents of the branching device time management table; and

FIG. 48 is a flowchart of an operation sequence of moving a transportation vehicle.

### BEST MODE FOR CARRYING OUT THE INVENTION

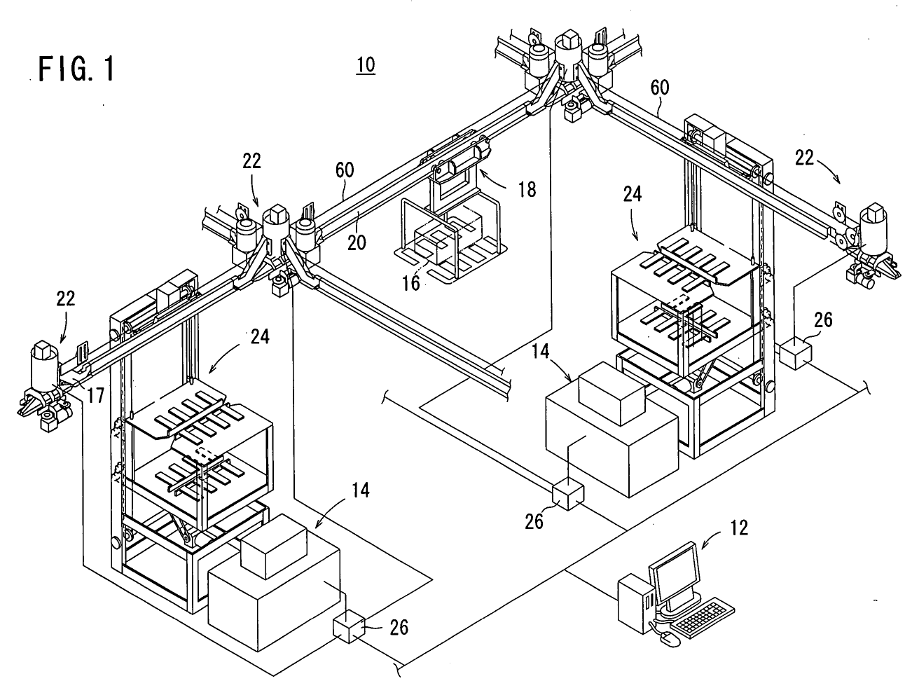

An embodiment of a method of and a system for transporting workpieces according to the present invention will be described below with reference to FIGS. 1 through 48.

As shown in FIG. 1, a workpiece transportation system 10 that is used in a workpiece transportation method according to the present embodiment comprises a plurality of transportation vehicles (transportation units) 18 for transporting workpieces 16, a plurality of transportation paths 20 for moving the transportation vehicles 18 with wires 60 and stopping them therealong, a plurality of mounting/dismounting devices (stations) 24 into which workpieces 16 are loaded from transportation vehicles 18 and from which workpieces 16 are unloaded to transportation vehicles 18, a plurality of processing machines 14 for machining workpieces 16 removed from the mounting/dismounting devices 24, a plurality of branching devices (relay paths) 22 disposed on relay points or ends of transportation paths 20 for stopping transportation vehicles 18 entering from transportation paths 20 or allowing transportation vehicles 18 to enter into other transportation paths 20, a plurality of unit controllers 26 for directly controlling operation of the transportation vehicles 18, the transportation paths 20, the mounting/dismounting devices 24, and the branching devices 22, and a main controller (control unit) 12 for controlling the unit controllers 26 in combination to control the entire system.

The term “loading” will hereinafter refer to a process of transferring a workpiece 16 from a transportation vehicle 18 to a mounting/dismounting device 24, and the term “unloading” will hereinafter refer to a process which is a reversal of the loading process.

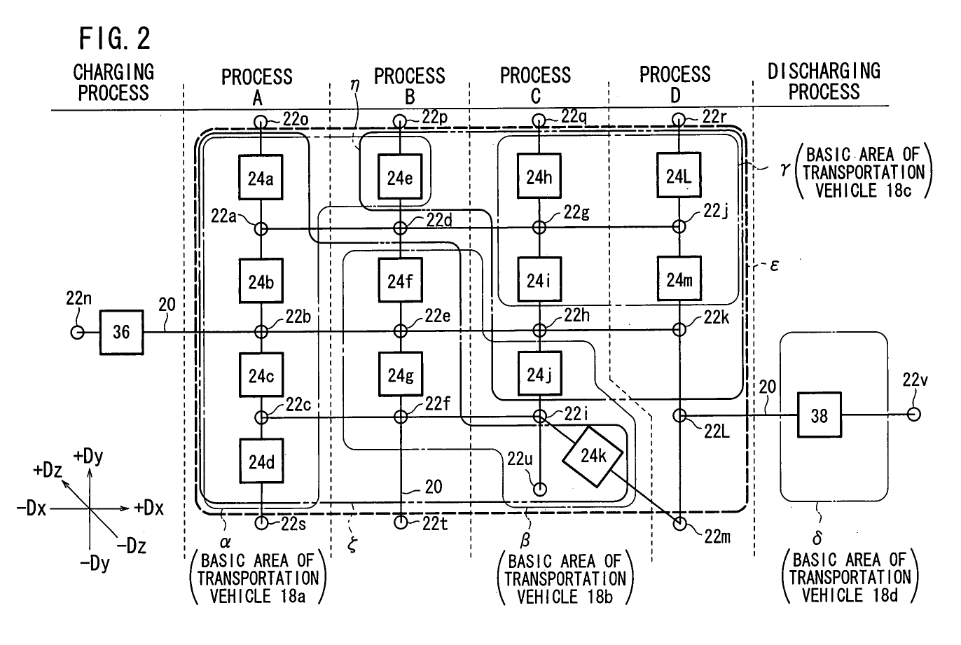

As shown in FIG. 2, there is a plurality of mounting/dismounting devices 24, and each of the mounting/dismounting devices 24a through 24m has a processing machine 14 (see FIG. 1) depending on a process of machining a workpiece 16. The workpieces 16 are classified into two types of workpieces 16a, 16b (both not shown). The processing machines 14 comprise a mixture of those processing machines for machining both types of workpieces 16a, 16b and those processing machines for machining either one of the types of workpieces 16a, 16b.

Machining processes for the workpieces 16 are classified successively into five processes including processes A, B, C, D and a discharging process. In a charging process, a workpiece 16 is transferred from a charging device 36 into the process A. When the processes B, C, D are finished on the workpiece 16, the workpiece 16 is delivered to a discharging device 38 in the discharging process. The charging device 36 and the discharging device 38 have respective functions to charge and discharge workpieces 16, and serve to transfer workpieces 16 to and from the transportation vehicles 18, as with the mounting/dismounting devices 24. The charging device 36 and the discharging device 38 will be treated in the same manner as the mounting/dismounting devices 24 in the description below.

The process A has mounting/dismounting devices 24a through 24d, the process B has mounting/dismounting devices 24e through 24g, the process C has mounting/dismounting devices 24h through 24k, and the process D has mounting/dismounting devices 24L through 24m. The mounting/dismounting devices 24a through 24m are connected to the charging device 36 and the discharging device 38 by the transportation paths 20 that are arranged in a network. The charging device 36, the discharging device 38, and the mounting/dismounting devices 24a through 24m are disposed on certain locations along the transportation paths 20.

A workpiece 16 is transported as follows: For example, it is charged from the charging device 36, then successively machined at the mounting/dismounting device 24g in the process B, the mounting/dismounting device 24k in the process C, and the mounting/dismounting device 24L in the process D, and thereafter discharged from the discharging device 38.

There is a plurality of branching devices 22 including branching devices 22a through 22m disposed on relay points of transportation paths 20 and branching devices 22n through 22v disposed on ends of transportation paths 20. The transportation paths 20 which extend from the relay points do not need to cross each other at 90°, but may extend at any angles to each other, as with the branching devices 22i, 22m. The transportation paths 20 which extend from the relay points do not need to comprise four crossing transportation paths, but may comprise a desired number of, e.g., two or three, transportation paths, as with the branching devices 22a, 22m, etc.

The mounting/dismounting devices 24a through 24m and the discharging device 38 are divided into a suitable number of basic areas, and transportation vehicles 18 are assigned respectively to the basic areas. When each of the transportation vehicles 18 loads a workpiece 16 into or receives a workpiece 16 from only the mounting/dismounting devices 24 or the discharging device 38 assigned thereto, the transportation also enters a basic area of a preceding process. When the transportation vehicle 18 avoids another transportation vehicle 18, it also enters another adjacent basic area.

In FIG. 2, four transportation vehicles 18a through 18d are assigned respectively to four basic areas α, β, γ, δ. In the basic area β to which the transportation vehicle 18b is assigned, the transportation vehicle 18b loads a workpiece 16 into the mounting/dismounting devices 24f, 24g, 24j, 24k that belong to the processes B, C, and the transportation vehicle 18b receives a workpiece 16 unloaded from the mounting/dismounting devices 24a, 24b, 24c, 24d, 24e, 24f, 24g that belong to the processes A, B which precede the processes B, C, respectively.

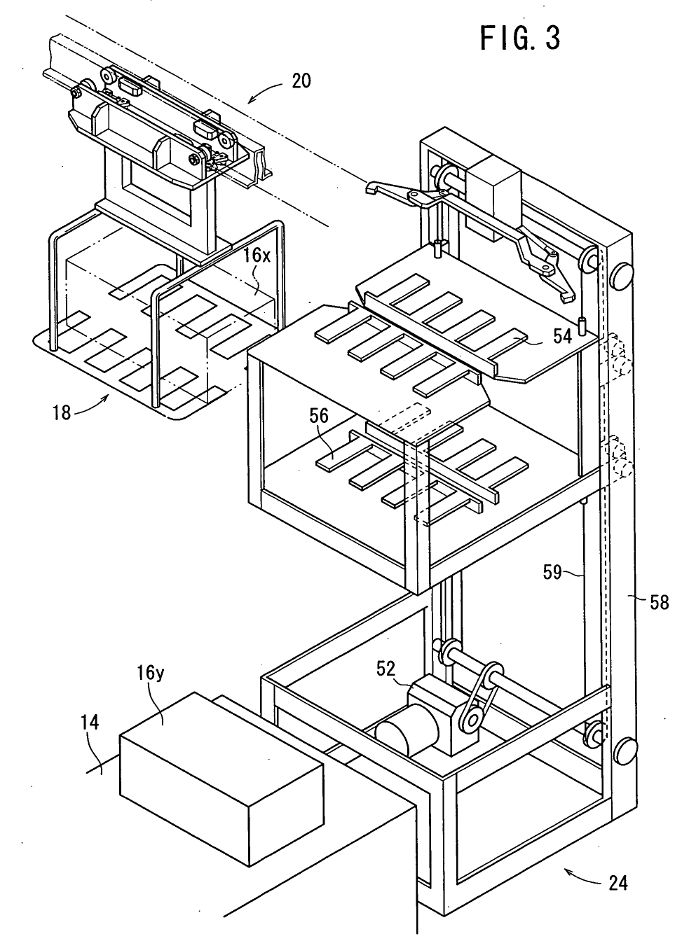

As shown in FIG. 3, each of the mounting/dismounting devices 24 is of a vertically long structure and has a pair of upstanding rails 58 on opposite sides each incorporating a chain and sprocket mechanism 59. Two upper and lower support bases 54, 56 which are integrally combined with each other and vertically spaced from each other project horizontally from the rails 58. The support bases 54, 56 are vertically movable along the rails 58 by the chain and sprocket mechanisms 59. The height of the support bases 54, 56 can be detected by a height sensor (not shown). The chain and sprocket mechanisms 59 are actuated by a motor 52 connected to the unit controller 26 (see FIG. 1) associated therewith, which can adjust the height of the support bases 54, 56 based on an output value of the height sensor.

The transportation vehicle 18 can load a workpiece onto and unload a workpiece from the upper support base 54. If there is no workpiece on the upper support base 54, the transportation vehicle 18 can unload a workpiece from the lower support base 56.

Specifically, when the transportation vehicle 18 puts an unprocessed workpiece 16x on the upper support base 54, the transportation vehicle 18 is retracted from the mounting/dismounting devices 24. The lower support base 56 is lowered to a height near the processing machine 14. After a processed workpiece 16y which has been machined by the processing machine 14 is put on the lower support base 56, the upper and lower support bases 54, 56 are further lowered until the upper support base 54 is positioned near the processing machine 14. The unprocessed workpiece 16x is transferred from the upper support base 54 to the processing machine 14, and thereafter, the upper and lower support bases 54, 56 are lifted. When the lower support base 56 reaches a height near the transportation vehicle 18, the transportation vehicle 18 moves from the retracted position to the loading position where the processed workpiece 16y is unloaded onto the transportation vehicle 18.

In this manner, the unprocessed workpiece 16x and the processed workpiece 16y can be loaded and unloaded between the mounting/dismounting devices 24, the processing machine 14, and the transportation vehicle 18.

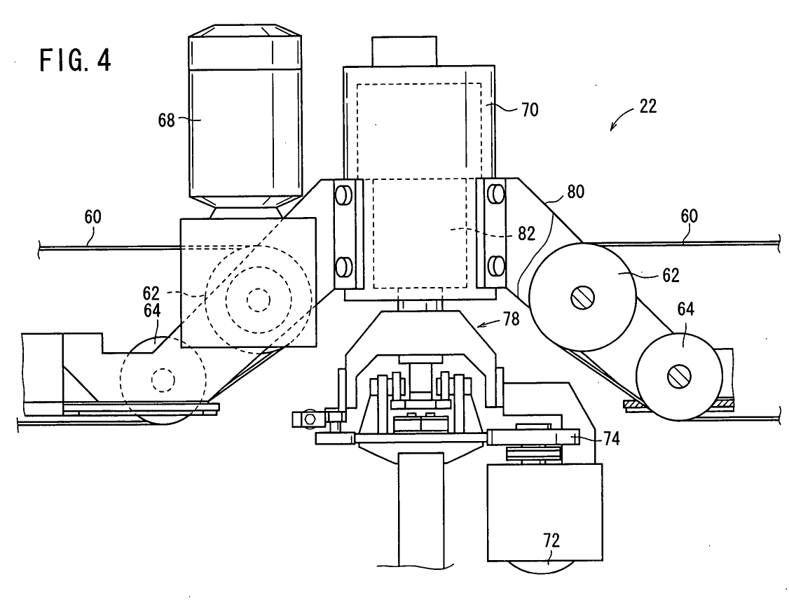

As shown in FIG. 4, each of the branching devices 22 comprises a branching device body 70, legs 80 projecting obliquely downwardly from the branching device body 70 and joined to transportation paths 20, a turn unit 78 disposed directly below the branching device body 70 and rotatable horizontally by a motor 82, a roller 74 mounted on the turn unit 78 for drawing in and pushing out a transportation vehicle 18, and a motor 72 for rotating the roller 74. The branching device 22 also has a motor 68 for driving wires 60 with pulleys 62, 64, an angle sensor (not shown) for detecting a turn angle of the turn unit 78, and a position sensor (not shown) for detecting a position of the transportation vehicle 18.

The branching device 22 can move the transportation vehicle 18 removably fixed to the wires 60 by driving the wires 60 with the motor 68. While the transportation vehicle 18 is in motion, it moves in unison with the wires 60 with a cam mechanism which grips and secures the wires 60. When the transportation vehicle 18 reaches the branching device 22, the cam mechanism is automatically released, and then the transportation vehicle 18 is drawn into the branching device 78 by the roller 74.

When the transportation vehicle 18 reaches the central position of the turn unit 78, the transportation vehicle 18 changes its orientation with the motor 82, and is pushed out onto another transportation path 20 by the roller 74. If two transportation paths 20 are arranged linearly and a transportation vehicle 18 travels linearly along those transportation paths 20 via the branching device 22, the turn unit 78 is not required to make a turning action, and the transportation vehicle 18 can travel relatively quickly through the branching device 22.

The motors 68, 72, 82, the position sensor, and the angle sensor of the branching device 22 are connected to the unit controller 26 (see FIG. 1) for controlling the position of the transportation vehicle 18 and the angle of the turn unit 78.

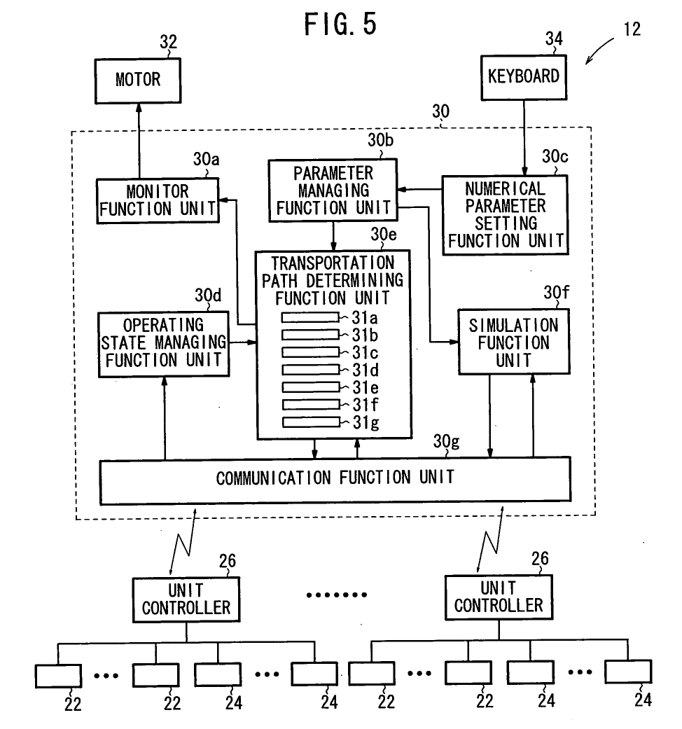

As shown in FIG. 5, the main controller 12 comprises a main assembly 30, a motor 32 for outputting images, and a keyboard 34 or the like of an input unit.

The main assembly 30 has a monitor function unit 30a for controlling the monitor 32, a parameter managing function unit 30b for holding various configurations of the workpiece transportation system 10, a numerical parameter setting function unit 30c for receiving commands and data from the keyboard 34 and transferring them to the parameter management function unit 30b, and a communication function unit 30g for communicating with the unit controllers 26 through a wired or wireless link.

The main assembly 30 also has an operating state managing function unit 30d connected to the communication function unit 30g for managing the state of the workpiece transportation system 10, a transportation path determining function unit 30e for determining paths along which to move the transportation vehicles 18 in coaction with the parameter managing function unit 30b, the operating state managing function unit 30d, etc., and a simulation function unit 30f for simulating the operation of the transportation vehicles 18.

The main assembly 30 has a hard disk, a CPU, a memory, etc. (not shown), and the function units 30a through 30f referred to above are normally stored as software in the hard disk. When these functions are to be performed, the software is loaded into the memory and executed by the CPU.

The transportation path determining function unit 30e has a request memory unit 31a for storing loading request signals and unloading request signals from the mounting/dismounting devices 24, and an operation plan updating unit 31b for updating the operation plans of the transportation vehicles 18 based on loading request signals and unloading request signals.

The transportation path determining function unit 30e also has a vector stipulating unit 31c for stipulating a reference vector from a start point to an end point for the transportation vehicles 18, and an angular range path selecting unit 31d for selecting, as a movement path, a transportation path 20 that is present in a predetermined angular range from the reference vector and includes the start point.

The transportation path determining function unit 30e further has a passage time calculating unit 31e for storing path candidates as strings of transportation paths 20 and branching devices 22 and determining a passage time required for a transportation vehicle 18 to pass through transportation paths 20 and branching devices 22, a standby time calculating unit 31f for determining a standby time in which a transportation vehicle 18 waits on transportation paths 20 and branching devices 22, and a transportation time totaling unit 31g for totaling the passage time and the standby time to calculate a transportation time for each path candidate.

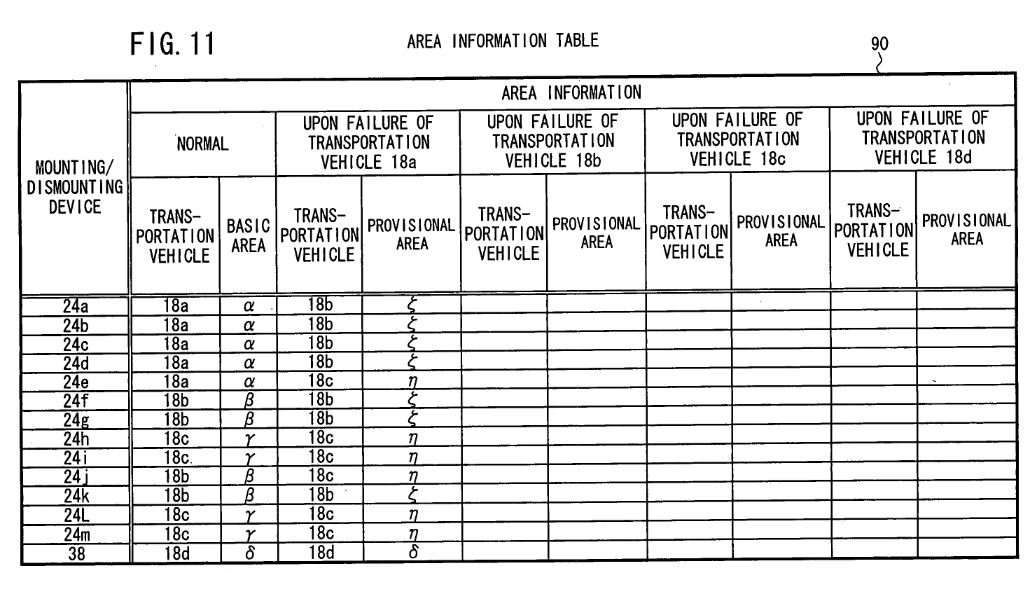

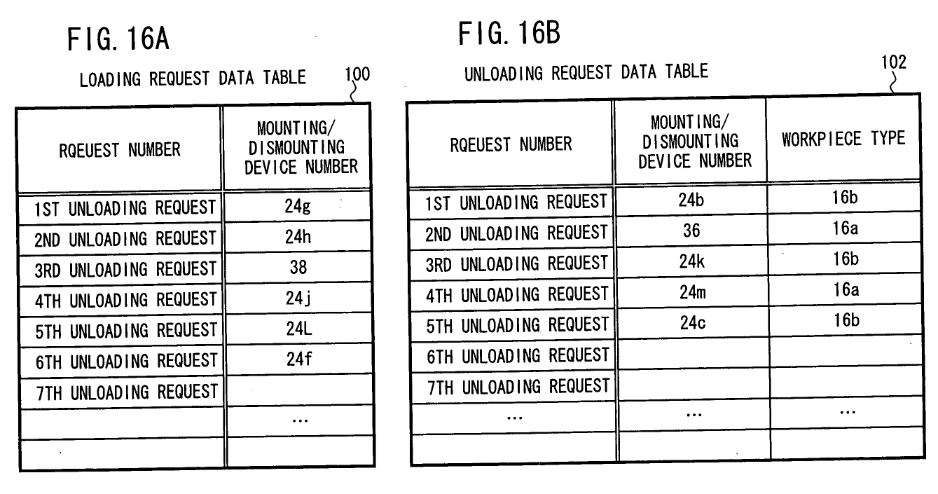

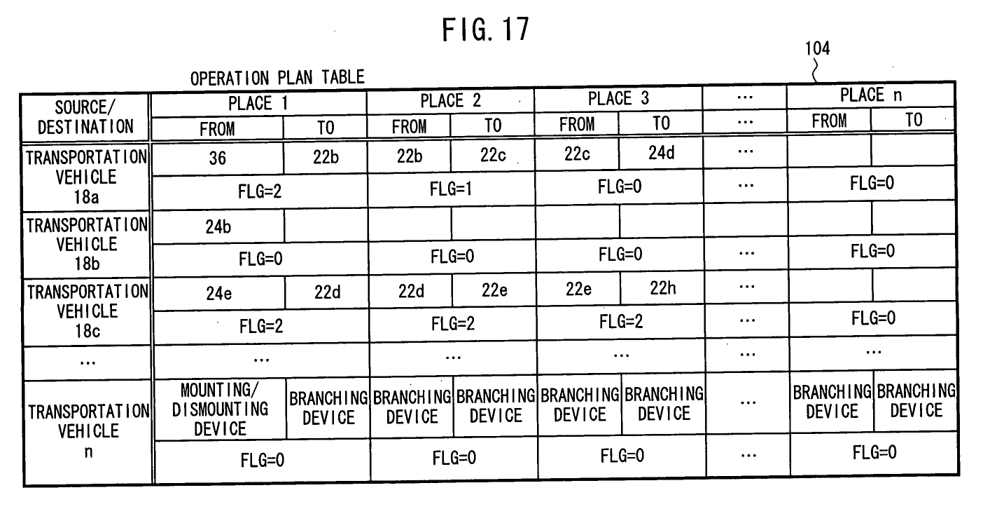

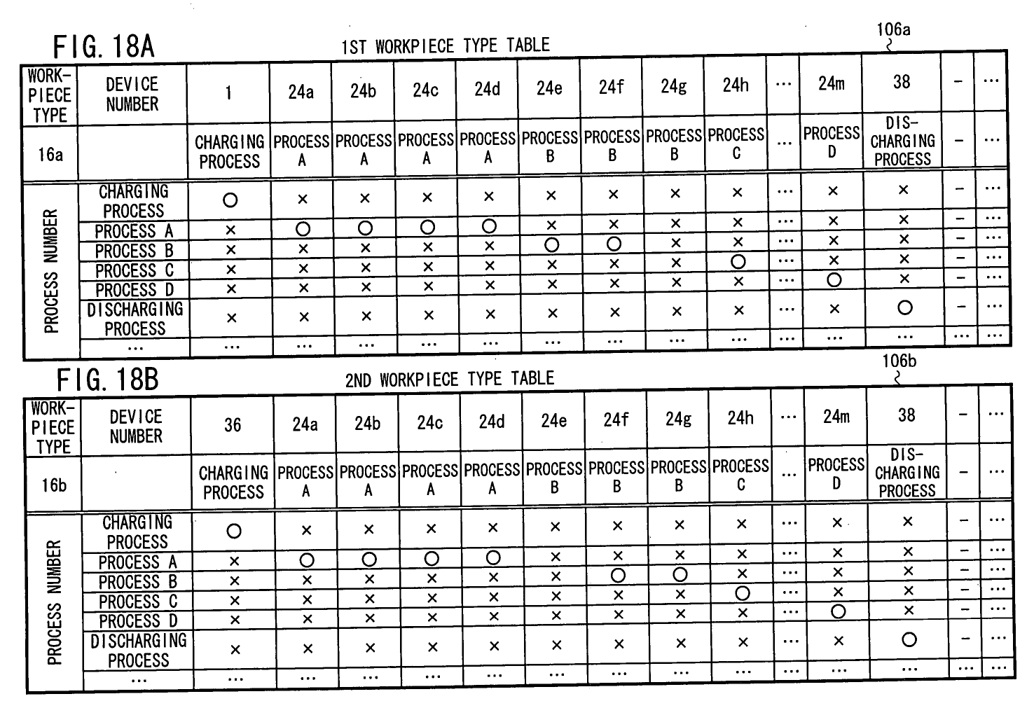

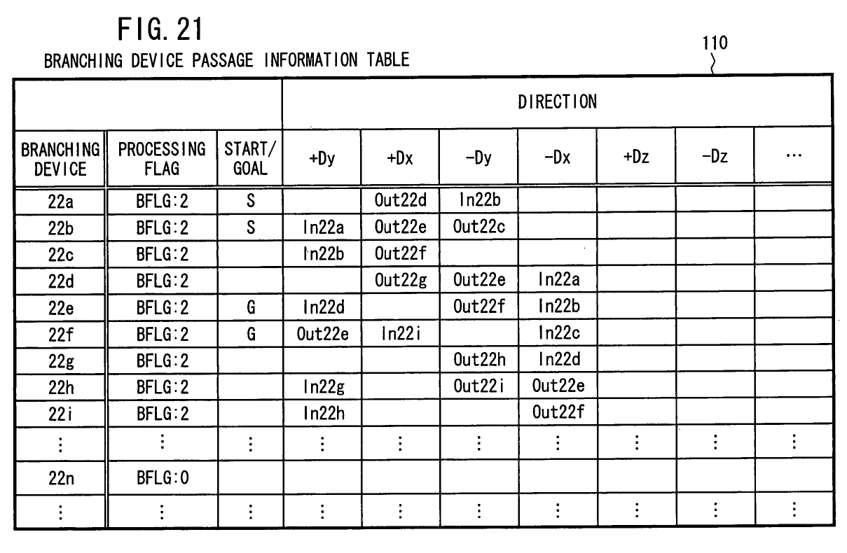

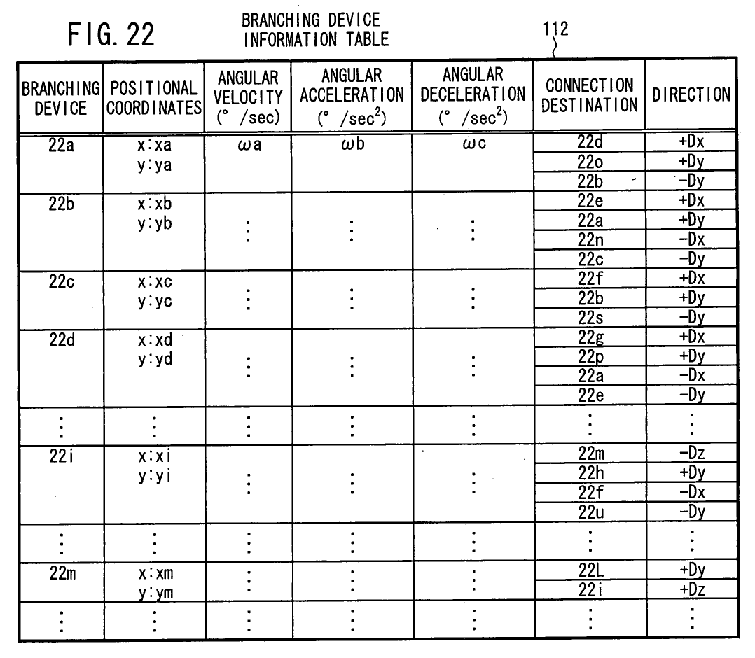

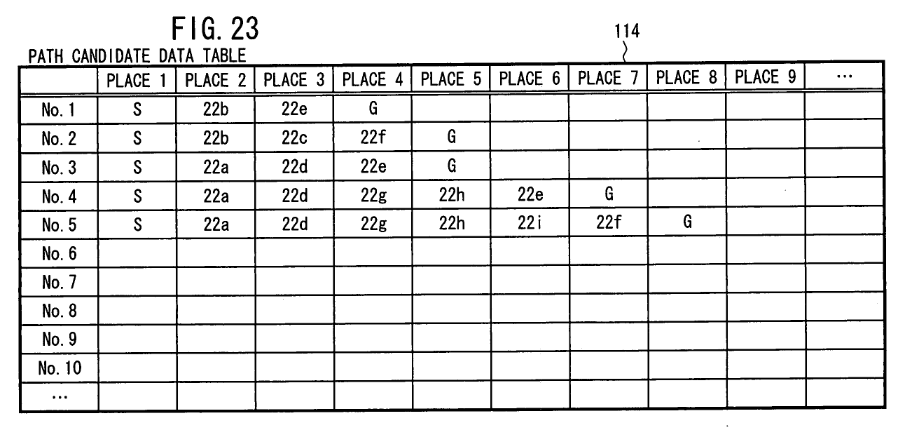

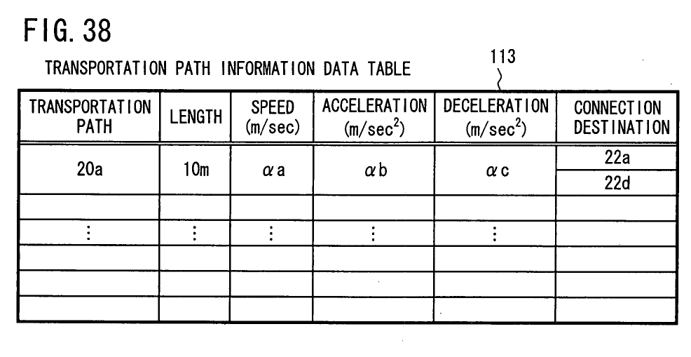

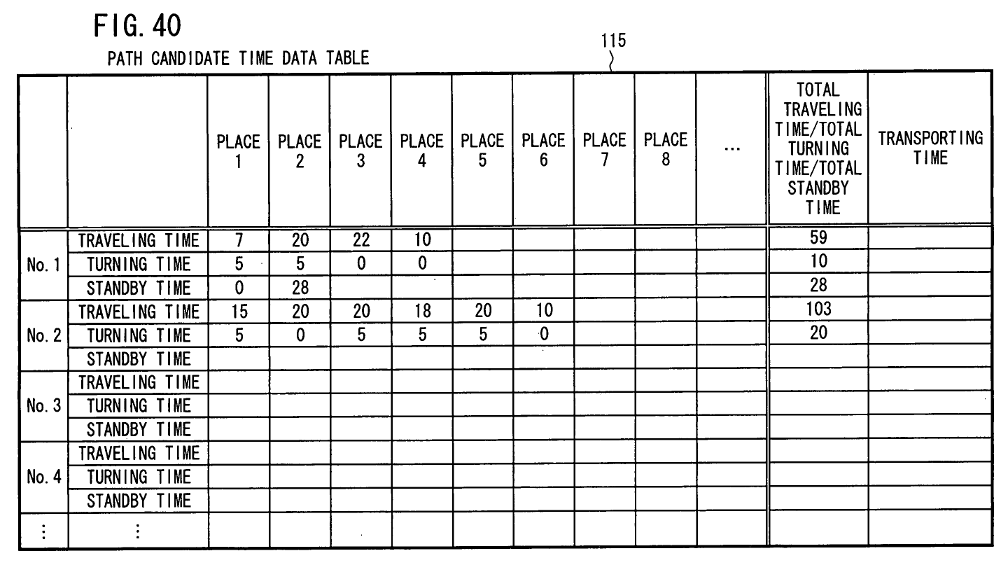

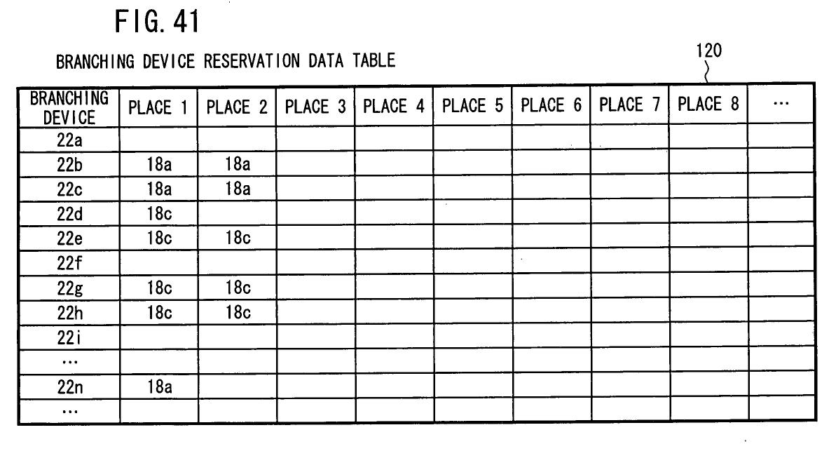

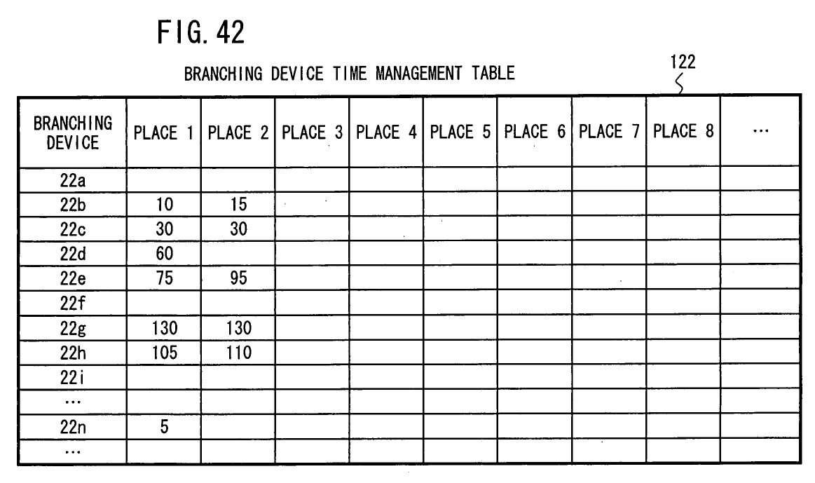

The transportation path determining function unit 30e mainly handles various tables including an area information table 90 (see FIG. 11), a loading request data table 100 (see FIG. 16A), an unloading request data table 102 (see FIG. 16B), an operation plan table 104 (see FIG. 17), a first workpiece type table 106a (see FIG. 18A), a second workpiece type table 106b, a branching device passage information table 110 (see FIG. 21), a branching device information table 112 (see FIG. 22), a transportation path information table 113 (see FIG. 38), a path candidate data table 114 (see FIG. 23), a path candidate time data table 115 (see FIG. 40), a branching device reservation data table 120 (see FIG. 41), and a branching device time management table 122 (see FIG. 42). These tables are actually set up on the hard disk or the memory, and referred to and updated by the CPU.

These tables should have a sufficiently large storage area capable of storing additional information and data when transportation vehicles 18 and mounting/dismounting devices 24 are added, the paths for transportation vehicles 18 are increased, and the number of processes is increased.

The area information table 90 is a table for storing basic areas that are determined. The loading request data table 100 is a table for storing loading request signals from mounting/dismounting devices 24 in chronological order. The unloading request data table 102 is a table for storing unloading request signals from mounting/dismounting devices 24 in chronological order. The operation plan table 104 is a table for storing operation plans of the transportation vehicles 18, respectively. The first workpiece type table 106a is a table for recording therein mounting/dismounting devices 24 (and processing machines 14) that are applicable to the workpieces 16a of the two types of workpieces 16a, 16b. The second workpiece type table 106b is a table for recording therein mounting/dismounting devices 24 (and processing machines 14) that are applicable to the workpieces 16b.

The branching device passage information table 110 is a table for describing directions in which a transportation vehicle 18 enters and travels for each branching device 22. The branching device information table 112 is a table for recording therein information about the positions and connection destinations of the branching devices 22. The transportation path information table 113 is a table for recording therein information about connection destinations of the transportation paths 20. The path candidate data table 114 is a table for describing a list of movement paths that have been searched for and selected. The path candidate time data table 115 is a table for calculating transportation times for movement path candidates. The branching device reservation data table 120 is a table for recording therein reservations to use transportation vehicles 18 for each branching device 22. The branching device time management table 122 is a table for recording therein reservation times for each branching device 22.

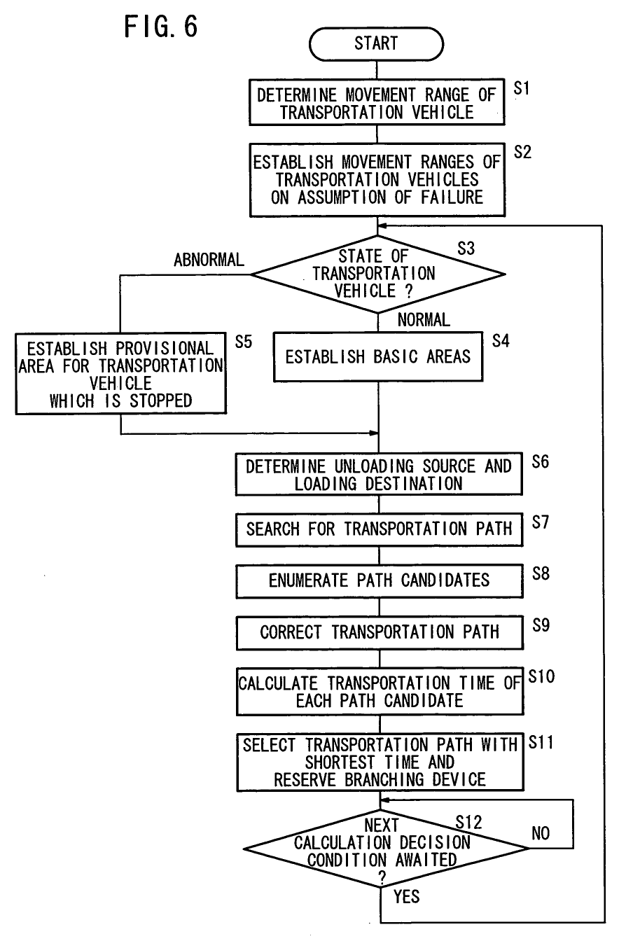

The main controller 12 and/or the operator determines transportation paths for transportation vehicles 18 according to an operation sequence represented by a main routine shown in FIG. 6. Specifically, a movement range assigned to each transportation vehicle 18 is determined and input (step S1). Then, on the assumption that one transportation vehicle 18 fails, movement ranges assigned to remaining transportation vehicles 18 are determined and input (step S2).

Thereafter, the main controller 12 (see FIG. 1) determines the state of each transportation vehicle 18 (step S3). The state of each transportation vehicle 18 is determined based on an excessive load signal detected by the branching devices 22, an error signal, and an operation speed of the transportation vehicle 18. If each transportation vehicle 18 is normal, then control goes to step S4. If any one of transportation vehicles 18 is abnormal, then control goes to step S5.

In step S4, the movement range determined in step S4 is applied. In step S5, the movement range determined in step S2 is applied.

Then, an unloading source and a loading destination for the transportation vehicle 18 are determined (step S6). After transportation paths for the transportation vehicle 18 are searched for (step S7), path candidates that have been searched for and determined are enumerated (step S8). The transportation paths are corrected to obtain reasonable transportation paths (step S9), and transportation times of the respective path candidates are calculated (step S10).

Then, a transportation path with the shortest transportation time is selected in view of actual operating conditions, and branching devices 22 are reserved to avoid conflicts with other transportation vehicles upon movement of the transportation vehicle 18 along the determined transportation path (step S11).

After all transportation paths that can be determined at that time have been determined, control waits until next calculation judging conditions are satisfied (step S12). The next calculation judging conditions are represented by a loading request signal from each mounting/dismounting device 24, an unloading request signal from each mounting/dismounting device 24, and information indicating that the transportation with the transportation vehicle 18 is finished or the transportation vehicle 18 has passed through a branching device 22. If the next calculation judging conditions are satisfied, then control returns to step S3.

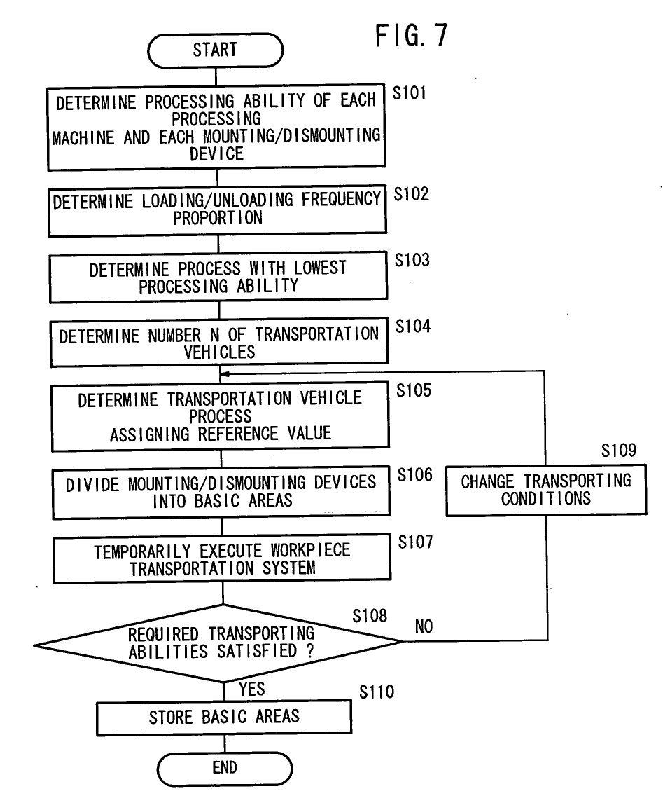

Step S1 of the main routine shown in FIG. 6, i.e., the process of determining a movement range assigned to each transportation vehicle 18, will be described in detail with reference to FIGS. 7 through 14.

The process in step S1 basically calculates the number of times that workpieces are loaded into and unloaded from the mounting/dismounting devices 24 and the discharging device 38 in view of their processing capability and standby times, and distributes the calculated number of times such that the loading and unloading events are handled equally by the transportation vehicles 18.

First, in step S101 shown in FIG. 7, the processing ability of each mounting/dismounting device 24 is determined.

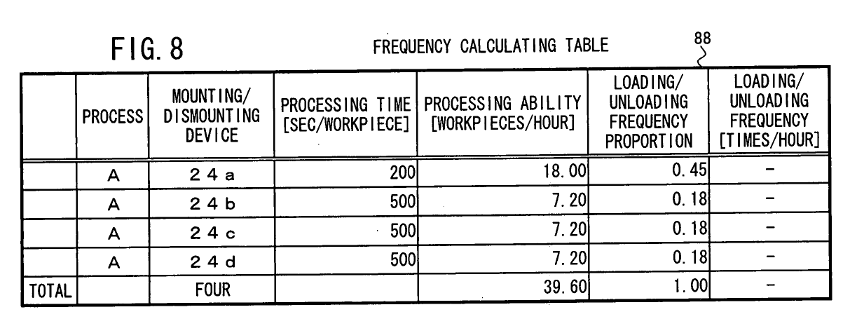

As indicated by examples of the process A in a frequency calculating table 88 shown in FIG. 8, processing times for processing a workpiece with the four mounting/dismounting devices 24a, 24b, 24c, 24d in the process A are given as 200, 500, 500, 500 [SEC/piece], and their reciprocals are multiplied by 3600 [SEC] (1 [HOUR]) to determine respective processing ability values 18.0, 7.2, 7.2, 7.2 [pieces/HOUR]. The overall processing ability of the process A is determined as 39.6 [pieces/HOUR] which is the sum of the above determined processing ability values. The frequency calculating table 88 shown in FIGS. 8, 9, and 14 is a table useful for determining processing abilities, and is used on the desk or personal computer by the operator. The frequency calculating table 88 is used for the convenience of calculations, and may be replaced with a predetermined formula.

The individual processing ability values of the mounting/dismounting devices 24 and the processing ability values of the respective processes represent values for processing workpieces if the mounting/dismounting devices 24 operate with an operating efficiency of 100% free of any standby times. If there occur standby times, then the processing ability values are lowered depending on the operating efficiency of the mounting/dismounting devices 24. However, even if there occur standby times, the ratio between the individual processing ability values of the mounting/dismounting devices 24 and the processing ability values of the respective processes is constant provided that the operating efficiencies of the mounting/dismounting devices 24 are the same as each other.

In step S102, the proportion of a frequency with which the mounting/dismounting devices 24 load or unload workpieces is determined for each process from the individual processing ability values and the processing ability values of the respective processes. Specifically, since the number of times that loading/unloading request signals are transmitted from each mounting/dismounting device 24 is proportional to the processing ability thereof, the proportion of a frequency with which each mounting/dismounting device 24 loads and unloads workpieces can be determined as a ratio with respect to the number of times that loading/unloading request signals are transmitted in the entire process.

In the example of the mounting/dismounting device 24a in the frequency calculating table 88 shown in FIG. 8, the frequency proportion is determined as a dimensionless number 18.0/39.6=0.45 and recorded in the column of “LOADING/UNLOADING FREQUENCY PROPORTION”. With respect to the mounting/dismounting devices 24b, 24c, 24d, the frequency proportions are similarly determined and recorded in the column. The sum of the numerical values of the determined frequency proportions for each process is “1.0”.

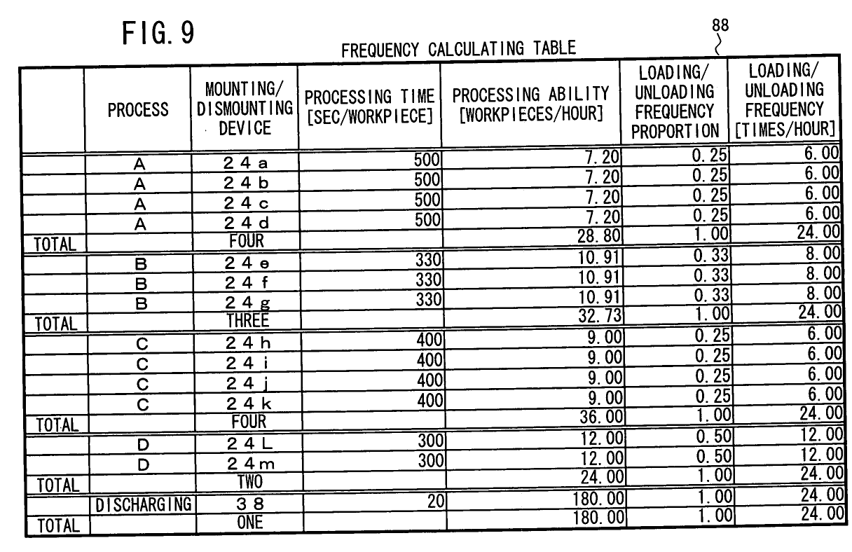

The processing times of the four mounting/dismounting devices 24a, 24b, 24c, 24d in the process A in the frequency calculating table 88 shown in FIG. 9 are 500 [SEC/piece] each. The processing times of the mounting/dismounting devices 24 in the processes B, C, D are of identical values for each process, and 330, 400, 300 [SEC/piece] for the respective processes. Loading/unloading frequency proportions can be expressed as the reciprocal 1/M of M where M [devices/process] represents the number of mounting/dismounting devices 24 in each process. For the process A, the loading/unloading frequency proportion may be calculated as ¼=0.25. The process shown in FIG. 7 will be described below with respect to the examples in the frequency calculating table 88 shown in FIG. 9.

In step S103, one of the processes A, B, C, D whose processing ability is the lowest is determined. The values of the processing abilities of the processes A, B, C, D are 28.8, 32.7, 36.0, and 24.0 [pieces/HOUR], respectively, as indicated in the cells “TOTAL” in the column of “PROCESSING ABILITY” in the frequency calculating table 88 shown in FIG. 9. If the discharging device 38 is regarded as one process, then its processing ability value is expressed as 180.0 [pieces/HOUR]. Of these processing ability values, the processing ability value of 24 [pieces/HOUR] of the process D is the lowest, and the processing abilities of the other processes are limited by the processing ability value of the process D.

In step S104, the number N of transportation vehicles 18 that are used is determined. The number N of transportation vehicles 18 is temporarily determined, and may be an empirically suitable number.

Then, in step S105, a loading/unloading process assigning reference value for the N transportation vehicles 18 is determined.

The number of loading/unloading events for each of the respective processes is regarded as 24 [times/HOUR] which is the same as 24 [pieces/HOUR] of the process D (bottleneck process) whose processing ability is the lowest. If the number of loading/unloading events is represented as a unit working quantity of “1”, then the working quantity of all the processes (the processes A through D and the discharging process) is represented as “5”.

Since the N transportation vehicles 18 should desirably be assigned to loading/unloading processes equally, the loading/unloading process assigning reference value is determined as 5/N with respect to the working quantity “5” for all the processes.

If the number N of transportation vehicles 18 is N=3, then the loading/unloading process assigning reference value is 5/31.67. This indicates that each transportation vehicle 18 may be assigned to 1.67 processes of all the five processes.

In step S106, the mounting/dismounting devices 24 are divided into a number N of basic areas. Specifically, the mounting/dismounting devices 24 are divided such that the sum of the loading/unloading frequency proportions determined in step S102 becomes as closely as possible to the loading/unloading process assigning reference value determined in step S105.

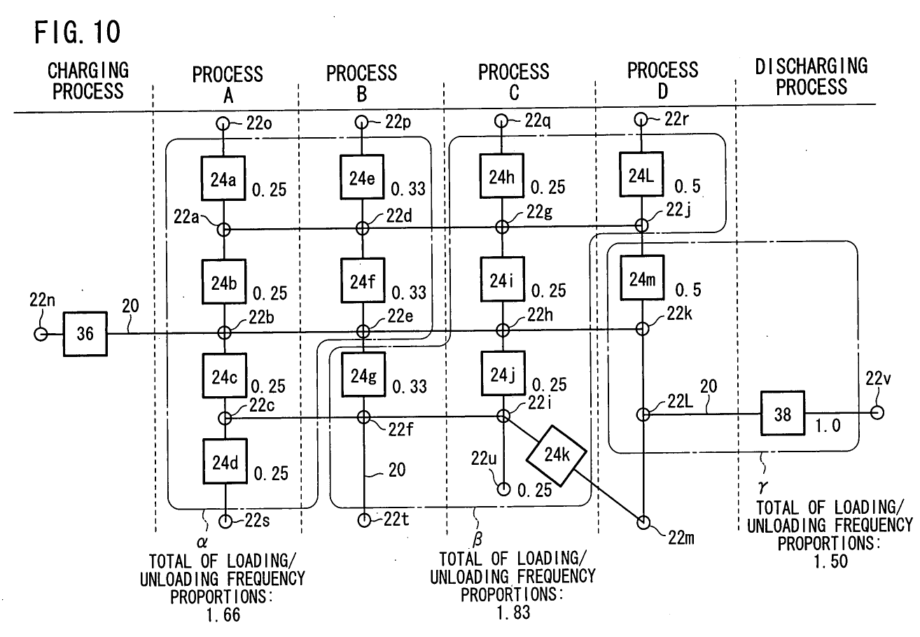

For example, if N=3 and the loading/unloading process assigning reference value is 1.67, then, as shown in FIG. 10, the basic areas a, α, β, γ may be established as basic areas assigned respectively to the transportation vehicles 18a, 18b, 18c. The basic area a assigned to the transportation vehicle 18a covers the mounting/dismounting devices 24a through 24f, the basic area β assigned to the transportation vehicle 18b covers the mounting/dismounting devices 24g through 24L, and the basic area γ assigned to the transportation vehicle 18c covers the mounting/dismounting device 24m and the discharging device 38. The total of loading/unloading frequency proportions in the basic area α is 1.66, and the totals of loading/unloading frequency proportions in the basic areas β, γ are 1.83 and 1.50, respectively. Since these values are not significantly different from the loading/unloading process assigning reference value of 1.67, it can be seen that the transportation vehicles 18a through 18c are assigned to substantially equal loading/unloading processes.

For determining whether the mounting/dismounting devices are properly divided into basic areas or not, a variance value of the total of loading/unloading frequency proportions in each basic area may be determined, and the magnitude of the variance value may be considered.

The mounting/dismounting devices may be divided into basic areas by the operator at their own discretion or may be divided into basic areas automatically according to a suitable sequence.

Since a loading destination for loading the workpiece 16 is defined as a basic area, as described above, it is not necessary to incorporate the charging device 36 into a basic area.

In step S107 shown in FIG. 7, the workpiece transportation system 10 is temporarily executed under the conditions that have been determined so far up to step S106. If it is difficult to temporarily operate and stop the workpiece transportation system 10 frequently, then the simulation function unit 30f of the main controller 12 may simulate such a temporary execution. Alternatively, a computer independent of the workpiece transportation system 10 may simulate such a temporary execution.

During the temporary execution, the number of workpieces 16 processed in the overall processes and the operating efficiency of the process D whose processing ability is the lowest are inspected. If a suitable period of time has expired, then the temporary execution is finished.

In step S108, it is determined whether a transportation ability that is required by the overall processes is satisfied or not according to two conditions.

The first condition is that the number of workpieces 16 per unit time which have to be processed in the overall processes is satisfied, and the second condition is that the operating efficiency of the process D whose processing ability is the lowest is 100%.

Specifically, the overall processes are normally given the number of workpieces 16 which have to be processed as a required specification, and the process D should desirably operate with the maximum operating efficiency because the lowest processing ability of the process D limits the processing abilities of the other processes A, B, C.

If it is confirmed that these conditions have been satisfied, then the determined basic areas α, β, γ are stored in the area information table 90 (see FIG. 11) (step S110). If the conditions have not been satisfied, then control goes to step S109.

Information about the basic areas α, β, γ is stored in the column “NORMAL” in the area information table 90, as shown in FIG. 11. Specifically, the numbers of the transportation vehicles 18 assigned to the loading process and the numbers of the basic areas α through δ are recorded respectively for the mounting/dismounting devices 24a through 24m and the discharging device 38. FIG. 11 shows an example in which the four transportation vehicles 18a through 18d are applied.

In step S109, transporting conditions for performing the temporary execution again are changed. The transporting conditions to be changed include an addition of a transportation vehicle 18, an addition of a transportation path 20, and an increase in the moving speed of a transportation vehicle 18.

For example, if there are three transportation vehicles 18 and the conditions in step S108 are not satisfied, then an attempt to increase the number of transportation vehicles 18 to “4” is considered. If it is decided that the number of transportation vehicles 18 is to be increased to “4”, then control goes back to step S105 in which the loading/unloading process assigning reference value is determined as 5/4=1.25. In step S106, the basic area assigned to the added transportation vehicle 18d, for example, is determined to be the basic area δ, and the basic areas α, β, γ, δ shown in FIG. 2, for example, are established. In this case, the sums of the loading/unloading frequency proportions in the respective basic areas α, β, γ, δ are 1.33, 1.16, 1.5, and 1.0, respectively, which are relatively in conformity with the loading/unloading process assigning reference value of 1.25.

If it is expected that the conditions in step S108 can be satisfied judging from the result of a simulation, then no conditions are change in step S109, and only the basic areas α, β, γ may be changed as shown in FIG. 10 in step S106.

Even if the conditions in step S108 are satisfied, if the operating efficiency of the transportation vehicles 18 is low, i.e., if their standby times are long, then the number of transportation vehicles 18 may be reduced and the temporary execution may be performed again.

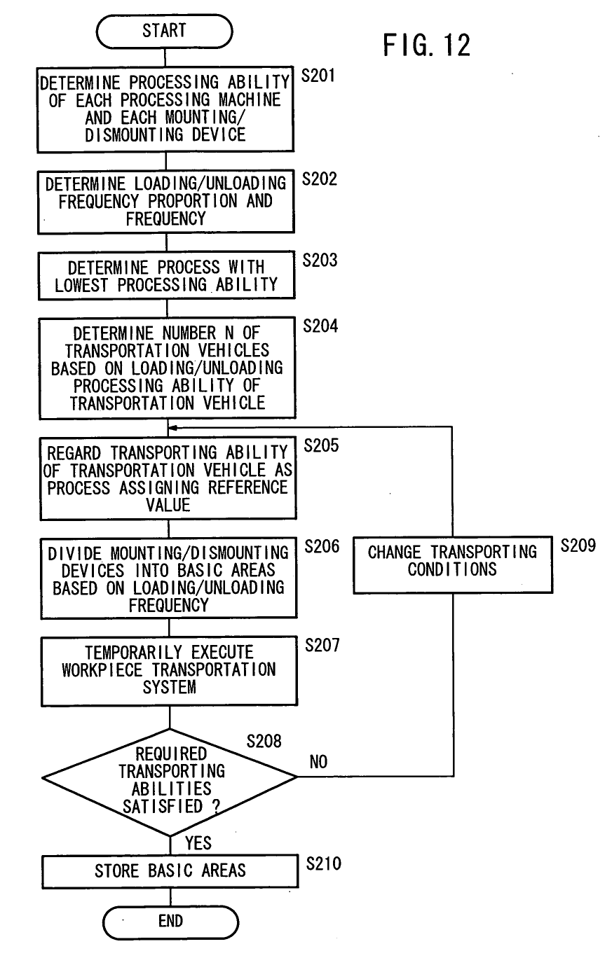

A first modification of step S1 will be described below with reference to FIGS. 9 and 12.

The first modification of step S1 is carried out according to essentially the same sequence as with the above embodiment, as shown in FIG. 12. Steps S201 through S210 shown in FIG. 12 correspond respectively to steps S101 through S110 shown in FIG. 7. Of those steps, steps S202, S204, S205, and S206 which are different from the sequence of the above embodiment will be described below.

In step S202, after the proportion of a frequency with which loading/unloading request signals are transmitted is determined for each process, in the same manner as with step S102, a loading/unloading frequency is determined. Specifically, since it is difficult to grasp how many times workpieces are loaded and unloaded from the numerical value of the loading/unloading frequency proportion with which loading/unloading request signals are transmitted, it is converted to a numerical value representative of the number of times that workpieces are loaded and unloaded per unit time, i.e., a loading/unloading frequency. If the unit time is one hour, then the loading/unloading frequency may be produced by multiplying the loading/unloading frequency proportion by 24 [workpieces/HOUR] which is a numerical value representative of the lowest processing ability of the process D. The loading/unloading frequencies [times/HOUR] of the respective mounting/dismounting devices 24 are now determined as indicated in the column [LOADING/UNLOADING FREQUENCY] in the frequency calculating table 88 shown in FIG. 9. When the numerical values of the loading/unloading frequencies for the respective processes are totaled, the sum is naturally 24 [times/HOUR].

In step S203, the process D whose processing ability is the lowest is determined, in the same manner as with step S103. Thereafter, in step S204, if the transporting ability of a transportation vehicle 18 is expressed by H [times/HOUR], then since the number of transportation vehicles 18 to be put into action can be calculated roughly as 24×5/H, the number N of transportation vehicles 18 is selected to be a natural number greater than the calculated value. In the above calculation, “24” represents the loading/unloading ability of the process D whose processing ability is the lowest, and “5” the number of processes.

In step S205, a loading/unloading process assigning reference value is determined. The transporting ability H [times/HOUR] of the transportation vehicles 18 is directly applied as the loading/unloading process assigning reference value.

In step S206, the mounting/dismounting devices 24 are divided into N basic areas in view of the N transportation vehicles 18, as with step S106. In this modification, however, the “loading/unloading frequency” determined in step S202, rather than the “loading/unloading frequency proportion”, is used as a numerical value which serves as a reference for dividing the mounting/dismounting devices 24. The mounting/dismounting devices 24 are selected such that the sum of the loading/unloading frequency proportions of the basic areas becomes as closely as possible to the transporting ability H [times/HOUR] of the transportation vehicles 18.

The processing in subsequent steps S207 through S210 is performed in the same manner as with steps S107 through Silo.

According to the first modification of step Si, instead of the “loading/unloading frequency proportion”, the “loading/unloading frequency” which is a multiple of the “loading/unloading frequency proportion” is used to determine transporting conditions. Though the first modification of step S1 is essentially the same as with the previous embodiment, it allows the review to be made on the basis of an easily understandable unit of [times/HOUR]. Since the transporting ability of the transportation vehicles 18 can be expressed in the same unit, it can easily be compared with the processing ability of the mounting/dismounting devices 24.

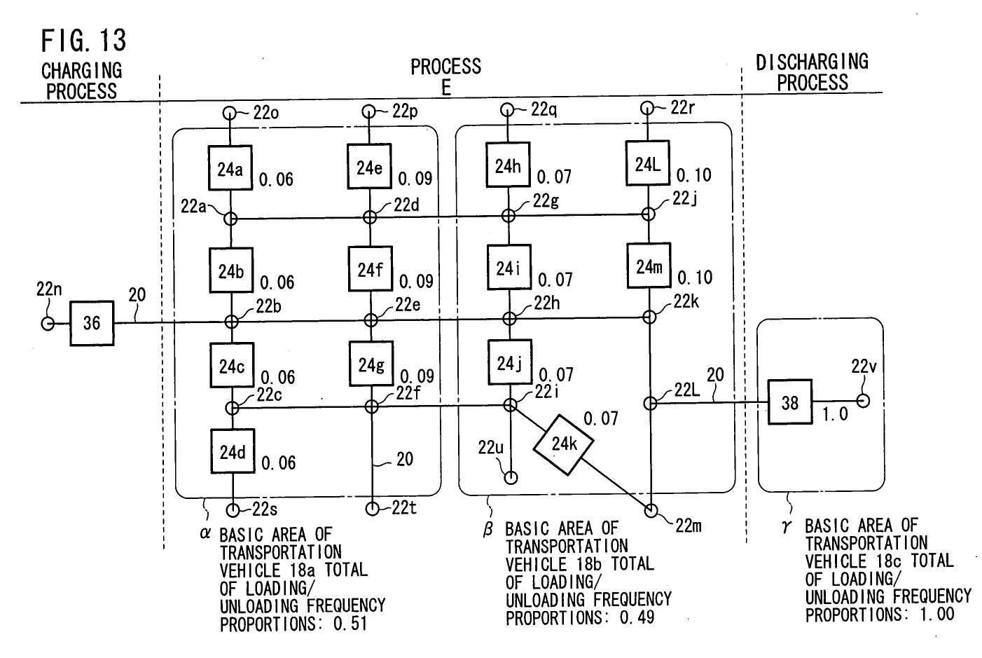

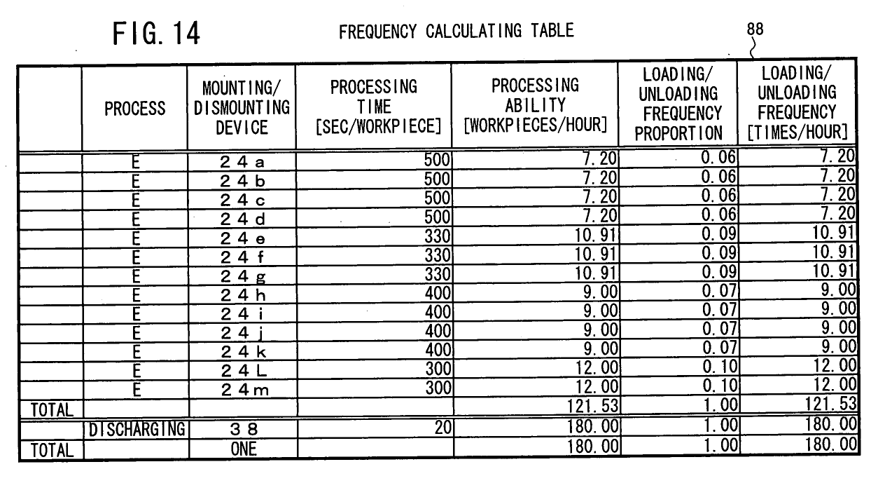

A second modification of step S1 will be described below with reference to FIGS. 13 and 14.

The second modification of step S1 is applicable to a system wherein the overall process comprises a single. process E as shown in FIG. 13. According to the second modification of step S1, transporting conditions can be established and confirmed in substantially the same manner as with the sequence shown in FIG. 7. However, the processing in step S103 (which determines a process whose processing ability is the lowest) is not required as there is only one process.

Specifically, if it is assumed that the processing times and processing abilities of the mounting/dismounting devices 24a through 24m are the same as the numerical values in the frequency calculating table 88 shown in FIG. 9, then the processing ability of the process E in its entirety can be determined as 121.53 [workpieces/HOUR] as indicated in the sum of the column “PROCESSING ABILITY” in a frequency calculating table 88 shown in FIG. 14.

The loading/unloading frequency proportion is determined by dividing the processing ability of each mounting/dismounting device 24 by the overall processing ability of 121.53 [workpieces/HOUR]. Inasmuch as there is no standby time occurring in each mounting/dismounting device 24, the numerical value of the loading/unloading frequency proportion is in conformity with the numerical value of the processing ability, and hence it may directly be copied.

The mounting/dismounting devices 24 are divided into basic areas such that the values of the loading/unloading frequency proportions or the loading/unloading frequencies become as closely as possible to each other in each basic area assigned to a transportation vehicle 18. For example, if the number N of transportation vehicles 18 is “3”, then mounting/dismounting devices 24 may be divided into the basic area α assigned to the transportation vehicle 18a, the basic area β assigned to the transportation vehicle 18b, and the basic area γ assigned to the transportation vehicle 18c.

The sum of loading/unloading frequency proportions is 0.51 in the basic area α, 0.49 in the basic area β, and 1.00 in the basic area γ. The numerical value of the sum of loading/unloading frequency proportions in the basic area γ is irregular because the basic area γ is assigned to the single discharging device 38 that cannot be divided. If the transporting ability required for the entire process in step S108 cannot be satisfied under the above transporting conditions, then one transportation vehicle 18 may be added, and the discharging device 38 may be provided by two transportation vehicles 18.

In the processing in step S1 in the main routine shown in FIG. 6, as described above, since the temporary execution is repeatedly performed while the number of transportation vehicles 18 and other devices is being increased or reduced and the basic areas assigned to the transportation vehicles 18 are being changed, preferred transporting conditions can be determined.

The processing in step S1 has the step of determining a frequency with which to load workpieces 16 into or unload workpieces 16 from each mounting/dismounting device 24, and the mounting/dismounting devices 24 are divided into basic areas depending on the number of transportation vehicles 18 such that the sums of frequencies are brought into substantial conformity with each other, after which the mounting/dismounting devices 24 are assigned to loading/unloading processes and perform such loading/unloading processes. Therefore, processing tasks can uniformly be distributed among the transportation vehicles 18. A plurality of (e.g., two) transportation vehicles 18 may be allocated to each basic area.

With the mounting/dismounting devices 24 divided into basic areas, the number of times that each transportation vehicle 18 enters other basic areas is reduced, with the result that the frequency with which transportation vehicles 18 conflict with each other on a path can be reduced.

Because the frequency is determined as a substantial frequency with which workpieces 16 are loaded or unloaded, including a time in which the mounting/dismounting devices 24 wait, a more accurate plan can be created than if the frequency were calculated only from the processing ability of the mounting/dismounting devices 24.

The mounting/dismounting devices 24 are divided into the processes A through D for processing workpieces 16 and the discharging process, and the loading/unloading frequency can be determined from the process assigning proportion of the mounting/dismounting devices 24 in each process.

According to the processing in step S1, a process whose average workpiece processing time is the longest, i.e., a bottleneck process in which the number of workpieces processed per unit time is the smallest, is determined, and the temporary execution is performed under such transporting conditions. As the operating frequency of the determined process is confirmed to be 100% by the temporary execution, it is possible for the overall processes to maintain a minimum operating ability. If the temporary execution is performed by a simulation on a computer, the time and electric power required to perform the temporary execution can be saved, and the temporary execution can be performed and stopped frequently. If the sum of loading/unloading frequencies is established so as to be in substantial conformity with the transporting frequency ability of the transportation vehicles 18, then the number of transportation vehicles 18 that are required can be calculated.

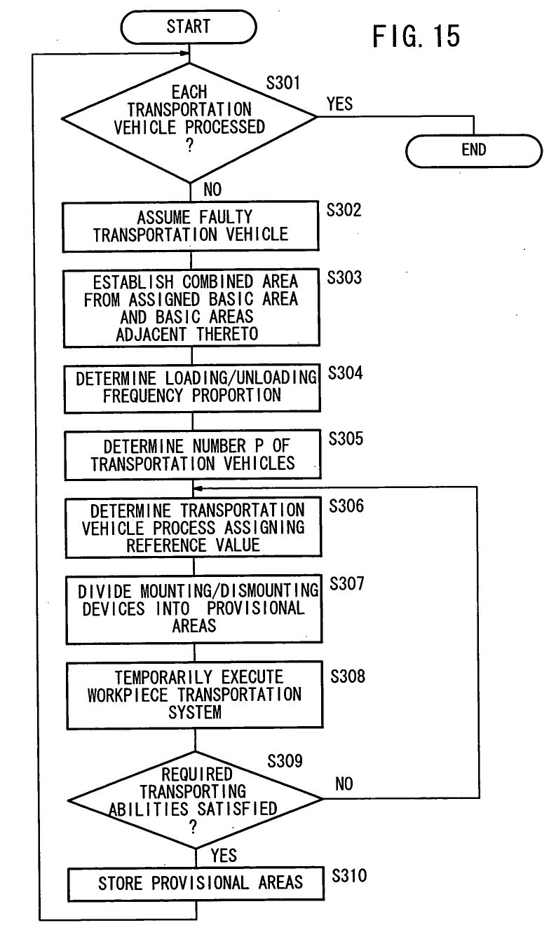

Step S2 in the main routine shown in FIG. 6, i.e., the process of determining movement ranges for remaining transportation vehicles 18 when one of the transportation vehicles 18 suffers a failure (including a functionality reduction or unavailability due to maintenance), will be described below with reference to FIGS. 2 and 15.

According to a sequence of a flowchart shown in FIG. 15, it is assumed that each of the transportation vehicles 18 suffers a failure, and the basic areas are re-divided to establish provisional areas such that the basic area assigned to a failing transportation vehicle 18 is assigned to another transportation vehicle 18.

First, in step S301 shown in FIG. 15, it is confirmed whether a process (S302 through S310) on the assumption that each of the transportation vehicles 18 suffers a failure has been performed or not. In the example shown in FIG. 2, if the setting of provisional areas with respect to the basic areas α through δ assigned to all the transportation vehicles 18a through 18d is finished, then the sequence shown in FIG. 12 is finished, and control returns to the sequence shown in FIG. 6. If there are transportation vehicles 18 that remain unprocessed, then control goes to step S302.

In step S302, one of the unprocessed transportation vehicles 18 is assumed to be a faulty transportation vehicle 18. In subsequent steps S303 through S310, a provisional area is established with respect to the basic area assigned to the transportation vehicle 18 that has been assumed to be a faulty one in step S302.

In step S303, one or two other basic areas adjacent to the basic area assigned to the transportation vehicle 18 that has been assumed to be a faulty one in step S302 is selected.

Adjacent basic areas to be selected may be basic areas having overlapping or adjacent processes between basic areas. Specifically, in the example shown in FIG. 2, the basic areas α, β are adjacent basic areas as they have the overlapping process B. The basic areas α, γ are adjacent basic areas as they include either one of the adjacent processes B, C. The basic areas β, δ are not adjacent basic areas as they are isolated from each other by the process D.

If there is one adjacent other basic area, then that basic area is selected. If there are two or more adjacent other basic areas, then one or two of those adjacent other basic areas are selected.

The criterion for selecting adjacent basic-areas is that the number of processes included in a combined area obtained as the result of the selection should be as small as possible. This is because if the number of processes included in a combined area is smaller, the number of processes included in a provisional area divided from the combined area is smaller, and the distance that the transportation vehicle 18 assigned to the provisional area travels is shorter. Therefore, a loss caused when workpieces 16 are transported thereby can be made smaller. In the example shown in FIG. 2,. the number of processes included in the combined area should preferably be 4 or less, and the number of processes included in the provisional area divided from the combined area should preferably be 3 or less.

A process of establishing a combined area on the assumption of a failure of each of the transportation vehicles 18a through 18d will be described below.

If it is assumed that the transportation vehicle 18a suffers a failure, then as can be seen from FIG. 2, basic areas adjacent to the basic area α assigned to the transportation vehicle 18a are the basic area β and the basic area γ. Therefore, these basic areas β and γ are selected and combined with the basic area α, making up a combined area ε.

The basic area α and the basic area β may be combined with each other. In this case, the obtained combined area is assigned to the single transportation vehicle 18b.

Though there is an alternative to combine the basic area α and the basic area γ, the single transportation vehicle 18c would be assigned to a range including the four processes A through D, resulting in a large transportation loss, and the alternative would be not appropriate.

It is assumed that the transportation vehicle 18b suffers a failure. The transportation vehicle 18b is assigned to the basic area β that extends over the processes B, C. The process B is included in the basic area α, and the process C is included in the basic area γ. Therefore, even when the transportation vehicle 18b suffers a failure, it is possible to transport workpieces in the order of the processes, and the workpiece transportation system 10 will not be shut off. However, if the mounting/dismounting devices 24f, 24g, 24i, and 24k included in the basic area β were not operated, the production efficiency would greatly lowered. Thus, the basic area β is combined with adjacent other basic areas, establishing a combined area.

Basic areas adjacent to the basic area β assigned to the transportation vehicle 18b are the basic area α and the basic area γ. Therefore, these basic areas α and γ are selected and combined with the basic area β, making up a combined area similar to the combined area ε.

If it is assumed that the transportation vehicle 18c suffers a failure, then one or two basic areas are selected from the basic areas α, β, and δ adjacent to the basic area γ assigned to the transportation vehicle 18c.

If it is assumed that the transportation vehicle 18d suffers a failure, then since only the basic area γ is adjacent to the basic area δ assigned to the transportation vehicle 18d, the basic area γ is selected.

In step S304, a frequency proportion with which to load and unload workpieces with each mounting/dismounting device 24 in the combined area is determined. The frequency proportion may be of the value determined in step S102. That is, the value of the loading/unloading frequency proportion in the frequency calculating table 88 shown in FIG. 9 may be used.

In step S305, the number P of transportation vehicles 18 in the combined area is determined. If the combined area is produced by combining two basic areas, then the number P is P=1, and if the combined area is produced by combining three basic areas, then the number P is P=2.

In step S306, a loading/unloading process assigning reference value for the P transportation vehicles 18 is determined.

The loading/unloading process assigning reference value may be produced by dividing the frequency proportion with which to load and unload workpieces with each mounting/dismounting device 24 in the combined area, by the number P.

For example, with respect to the combined area ε (see FIG. 2) on the assumption that the transportation vehicle 18a suffers a failure, the sum of frequency proportions (see FIG. 9) with which to load and unload workpieces with each mounting/dismounting device 24 is “4” and the number P is “2”. Therefore, the loading/unloading process assigning reference value is determined as 4/2=2.

In step S307, the mounting/dismounting devices in the combined area is divided into provisional areas depending on the number P. In each provisional area, the mounting/dismounting devices 24 are selected such that the sum of loading/unloading frequency proportions (see FIG. 9) determined in step S304 becomes as closely as possible to the loading/unloading process assigning reference value determined in step S306.

For example, with respect to the combined area ε, it is preferable to establish two provisional areas ζ, η. Since the provisional area ζ includes the mounting/dismounting devices 24a, 24b, 24c, 24d, 24f, 24g, and 24k, the sum of loading/unloading frequency proportions (see FIG. 9) in the provisional area ζ is 0.25×4+0.33×2+0.25=1.91. Since provisional area η includes the mounting/dismounting devices 24e, 24h, 24i, 24j, 24L, and 24m, the sum of loading/unloading frequency proportions in the provisional area η is 0.33+0.25×3+0.5×2=2.08. These values of 1.91 and 20.8 are not significantly different from the loading/unloading process assigning reference value of 2.0, it can be seen that the transportation vehicles 18a and 18c are assigned to substantially equal loading/unloading processes.

In each of the provisional areas ζ, η, the number of processes is “3”. Therefore, it is relatively smaller than the total number “5” of processes, and hence a transportation loss is small and appropriate.

In step S307, if P=1, then it is not necessary to divide the mounting/dismounting devices into basic areas, and the combined area serves directly as a provisional area.

In step S308, the workpiece transportation system 10 is temporarily executed. The temporary execution is performed in the same manner as with step S107 described above, and may be simulated by a computer.

In step S309, it is determined whether a transportation ability that is required by the overall processes is satisfied or not according to two conditions, in the same manner as with step S108. However, since the temporary execution is based on the assumption that either one of the transportation vehicles 18a through 18d suffers a failure, the conditions in step S108 may somewhat be less stringent. For example, the operating efficiency of the bottleneck process D may be set to a value smaller than 100%.

If it is confirmed that these conditions are satisfied, then the determined provisional areas ζ, η, etc. are stored in the area information table 90 (see FIG. 11) of the main controller 12 (step S310). If the conditions are not satisfied, then control goes back to step S306.

Information as to the provisional areas ζ, η is stored in the column “UPON FAILURE OF TRANSPORTATION VEHICLE 18a” in the area information table 90, as shown in FIG. 11. Specifically, the numbers of the transportation vehicles 18 assigned to the loading process and the numbers of the provisional areas ζ, η are recorded respectively for the mounting/dismounting devices 24a through 24m and the discharging device 38. The basic area δ that remains unchanged is also recorded. When the transportation vehicles 18b, 18c, 18d other than the transportation vehicle 18a fail, information as to established provisional areas is also recorded in the area information table 90.

When either one of the transportation vehicles 18a through 18d suffers a failure, the corresponding column of the area information table 90 is referred to for immediately establishing provisional areas.

In the processing in step S2 in the main routine shown in FIG. 6, as described above, since the temporary execution is repeatedly performed while the number of transportation vehicles 18 and other devices is being increased or reduced and the basic area assigned to the transportation vehicles 18 are being changed, preferred transporting conditions can be determined.

Furthermore, as a frequency with which each mounting/dismounting device 24 loads and unloads workpieces 16 is determined and the mounting/dismounting devices 24 are divided into basic areas depending on the number of transportation vehicles 18 such that the sums of frequencies are in substantial conformity with each other, the processing tasks of the transportation vehicles 18 assigned to the respective basic areas are substantially uniformized.

With the transportation vehicles 18 assigned to the respective basic areas, the number of times that each transportation vehicle 18 enters other basic areas is reduced, with the result that the number of times that transportation vehicles 18 conflict with each other on a path can be reduced. This holds true if provisional areas are applied, and since each of the transportation vehicles 18a through 18d has its handling area fixed to a basic area or a provisional area, the number of times that transportation vehicles 18 conflict with each other can be reduced.

Because the frequency is determined as a substantial frequency with which workpieces 16 are loaded or unloaded, including a time in which the mounting/dismounting devices 24 wait, a more accurate plan can be created than if the frequency were calculated only from the processing ability of the mounting/dismounting devices 24.

The mounting/dismounting devices 24 are divided into the processes A through D for processing workpieces 16 and the discharging process, and the loading/unloading frequency can be determined from the process assigning proportion of the mounting/dismounting devices 24 in each process.

Of the processes, a process whose average workpiece processing time is the longest, i.e., a bottleneck process in which the number of workpieces processed per unit time is the smallest, is determined, and the temporary execution is performed under such transporting conditions. As the operating frequency of the determined process is confirmed to be 100% by the temporary execution, it is possible for the overall processes to maintain a minimum operating ability. If the temporary execution is performed by a simulation on a computer, the execution time and electric power can be saved, and the temporary execution can be performed and stopped frequently. If the sum of loading/unloading frequencies is established so as to be in substantial conformity with the transporting frequency ability of the transportation vehicles 18, then the number of transportation vehicles 18 that are required can be calculated.

According to the processing in step S2, when each of the transportation vehicles 18a through 18d suffers a failure, it is possible to quickly go to a mode in which the operation of the workpiece transportation system 10 continues. Specifically, on the assumption that each of the transportation vehicles 18a through 18d suffers a failure, provisional areas assigned to the remaining transportation vehicles are established and stored. When an actual failure happens, these provisional areas are applied to allow the workpiece transportation system to handle such a situation with almost no time lag involved.

Since operation of each transportation vehicle 18 at the time provisional areas are applied is confirmed by a simulation, workpieces 16 can be transported relatively efficiently even in the event of a failure.

Provisional areas are established by setting a combined area including areas adjacent to the basic area that has been assigned to a transportation vehicle 18 which has failed to operate, and dividing the combined area into provisional areas. Consequently, basic areas not included in the combined area are not affected. Therefore, provisional areas can easily be established as they may be established only in the combined area. When one of the transportation vehicles 18 suffers a failure, other transportation vehicles 18 whose assigned basic areas are changed to provisional areas are two transportation vehicles at most, and other transportation vehicles than those transportation vehicles are not affected.

When a faulty transportation vehicle 18 becomes operational again, the stored original basic areas α, β, γ, δ are applied again (step S4 in FIG. 6), thus immediately restoring the workpiece transportation system back to its original state.

In the processing in step S1 or step S2, the mounting/dismounting devices 24 may either load or unload workpieces. For example, if a molding machine which stores a material molds a product from the material and thereafter unloads the product, then such a molding machine is not required to load a material.

The mounting/dismounting devices may be divided into basic areas in steps S106, S307 automatically according to a suitably determined sequence. For example, if the number N of transportation vehicles 18 is “3”, then first through third basic areas are hypothetically established, and the mounting/dismounting devices 24 and the discharging device 38 are distributed and recorded. If the devices are selected and distributed successively in the descending order of loading/unloading frequency proportions, then it is possible to automatically distribute the transportation vehicles 18 such that their processing tasks are substantially uniformized. According to this procedure, one basic area may be broken into a plurality of discrete portions. However, this procedure is applicable without any problems if the moving speed of the transportation vehicles 18 is sufficiently high compared with the processing times of the mounting/dismounting devices 24 and the discharging device 38.

In steps S106 and S307, the mounting/dismounting devices are divided into basic areas such that the processing tasks of the transportation vehicles 18 are uniformized. However, if there is a plurality of types of transportation vehicles 18 and they have different transporting abilities, then the transportation vehicles 18 may be distributed depending on their ability values.

Tables used in step S6 in the main routine shown in FIG. 6, i.e., the process of determining unloading sources and loading destinations, will be described in detail below with reference to FIGS. 16A through 18B.

A loading request data table 100 shown in FIG. 16A stores received loading request signals in a chronological sequence, and deletes those loading request signals therefrom when they are processed. A loading request signal is transmitted from the unit controllers 26 to the main controller 12 if the sum of the number of workpieces 16 in the mounting/dismounting devices 24 and the number of workpieces 16 in the processing machines 14 is smaller than 2.

An unloading request data table 102 shown in FIG. 16B stores received unloading request signals in a chronological sequence, and deletes those loading request signals therefrom when they are processed. An loading request signal is transmitted from the unit controllers 26 to the main controller 12 when processed workpieces 16 are transferred from the processing machines 14 to the mounting/dismounting devices 24. An loading request signal includes type information of a workpiece 16y that can be unloaded as “16a” or “16b”, and is stored in the unloading request data table 102. Workpieces 16 may be available in three or more types.

In the examples of the loading request data table 100 shown in FIG. 16A and the unloading request data table 102 shown in FIG. 16B, six loading requests and five unloading requests, respectively, are shown as remaining unprocessed.

An operation plan table 104 shown in FIG. 17 represents operation plans and operation states of the respective transportation vehicles 18. The operation plans and operation states of the respective transportation vehicles 18 are recorded in ascending order in the rightward direction across the columns from the place 1. The places are associated with respective operation flags FLG.

The transportation vehicle 18a will be described below. The transportation vehicle 18a has the charging device 36 as the unloading source, the mounting/dismounting device 24d as the loading destination, and the places as the charging device 36, the branching device 22b, the branching device 22c, and the mounting/dismounting device 24d. The place 1 defines a path from the charging device 36 to the branching device 22b, and its operation state flag FLG is “2” indicating an operation completion. The place 2 defines a path from the branching device 22b to the branching device 22c, and its operation state flag FLG is “1” indicating an operation in progress. The place 3 defines a path from the branching device 22c to the mounting/dismounting device 24d, and its operation state flag FLG is “0” indicating an operation not yet started. At this time, therefore, it is indicated that the transportation vehicle 18a is present in the branching device 22b or is moving toward the branching device 22c.

With respect to the transportation vehicle 18b, only the mounting/dismounting device 24b is recorded in the place 1, and its operation state flag FLG is “0”, indicating that the transportation vehicle 18b is idle at the mounting/dismounting device 24b.

A first workpiece type table 106a shown in FIG. 18A records data indicative of whether the workpiece 16a can be processed in the respective mounting/dismounting devices 24 (and the processing machines 14) or not in each of the processes A, B, C, D.

With respect to the process B, for example, of the mounting/dismounting devices 24e, 24f, 24g, the mounting/dismounting devices 24e, 24f for the process B are recorded with “◯” indicating that they are applicable to the workpiece 16a, and the mounting/dismounting device 24g with “×” indicating that it is not applicable to the workpiece 16a.

A second workpiece type table 106b shown in FIG. 18B records data indicative of whether the workpiece 16b can be processed or not as with the workpiece 16a.

With respect to the process B, for example, of the mounting/dismounting devices 24e, 24f, 24g, the mounting/dismounting devices 24f, 24g for the process B are recorded with “◯” indicating that they are applicable to the workpiece 16b, and the mounting/dismounting device 24e with “×” indicating that it is not applicable to the workpiece 16b. It can be seen that the mounting/dismounting devices 24e, 24g are devices dedicated to the workpiece 16a or 16b.

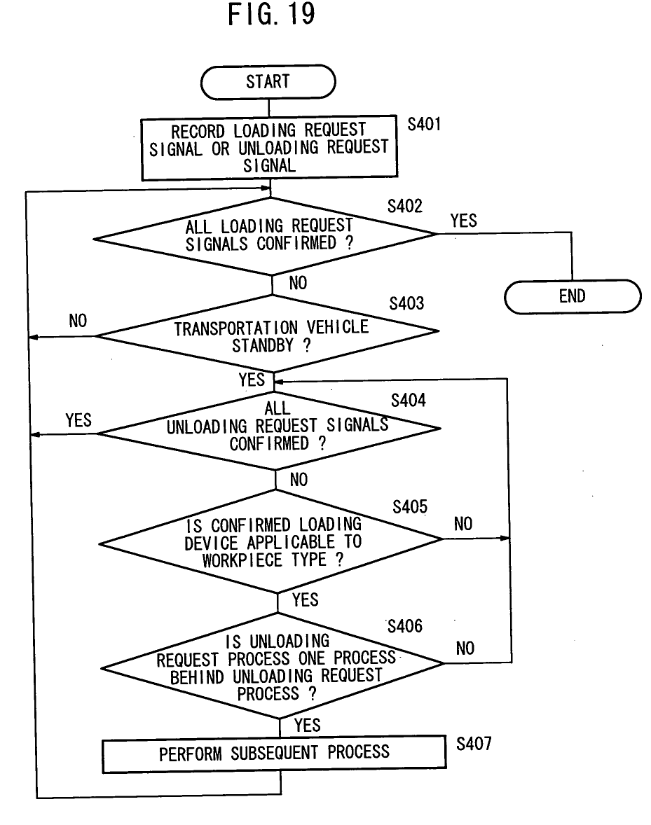

The processing in step S6, i.e., a sequence for determining an unloading source and a loading destination, will be described in detail below with reference to FIG. 19.

The processing in step S6 basically stores loading request signals and unloading request signals from the mounting/dismounting devices 24 in chronological order in a table, and updates the operation plans of the transportation vehicles 18 based on the stored loading request signals and unloading request signals. The main controller 12 performs the processing in step S6 mainly with the function of the transportation path determining function unit 30e.

In step S401, if there is a newly received loading request signal or unloading request signal, then the request memory unit 31a stores the loading request signal or unloading request signal in the uppermost row in a blank area in the loading request data table 100 or the unloading request data table 102. In the unloading request data table 102, the type of workpieces 16a or 16b that can be unloaded is simultaneously recorded in the same row.

Subsequent steps S402 through S407 are performed by the operation plan updating unit 31b.

In step S402, the oldest one of loading request signals that have been unprocessed, i.e., the number of the mounting/dismounting device 24 in the uppermost row in the loading request data table 100, is confirmed. Then, control goes to next step S403. When control returns through a loop of steps S403, S404, S407 to step S402, the number of the next mounting/dismounting device 24 in the recorded order in the loading request data table 100 is confirmed. If all of the loading request signals in the loading request data table 100 are confirmed, then the processing in step S6 is put to an end.

In step S403, the number of the transportation vehicle 18 assigned to the confirmed mounting/dismounting device 24 and the operation plan table 104 are referred to for confirming whether the transportation vehicle 18 is idle or not. If the transportation vehicle 18 is in operation, then control returns to step S402. If the transportation vehicle 18 is idle, then control goes to step S404.

If the mounting/dismounting device 24g is checked, then since the transportation vehicle which is assigned to the mounting/dismounting device 24g is the transportation vehicle 18b (see FIG. 2), the column of the transportation vehicle 18b in the operation plate table 104 is referred to and it is confirmed that the transportation vehicle 18b is idle. Control thus goes to step S404.

In step S404, the oldest one of loading request signals that have been unprocessed, i.e., the number of the mounting/dismounting device 24 in the uppermost row in the unloading request data table 102, and the type of the workpiece 16 are confirmed. Then, control goes to next step S405. When control returns through a loop of steps S405, S406 to step S404, the number of the next mounting/dismounting device 24 and the type of the workpiece 16 in the recorded order in the unloading request data table 102 are confirmed. If all of the unloading request signals in the unloading request data table 102 are confirmed, then control goes back to step S402.

In step S405, the first workpiece type table 106a or the second workpiece type table 106b which corresponds to the confirmed type of the workpiece 16 is referred to for checking if the mounting/dismounting device 24 confirmed in step S402 is applied to the workpiece type or not. If the corresponding column is recorded with “×” indicating that it is not applicable, then control returns to step S404. If the corresponding column is recorded with “◯” indicating that it is applicable, then control goes to step S406.

For example, if the type of the workpiece 16 is “16b” and the mounting/dismounting device 24 which transmits a loading request is the mounting/dismounting device 24g, then the second workpiece table 106b corresponding to the workpiece 16b is referred to. Since the mounting/dismounting device 24g belongs to the process B and is applicable to the workpiece 16b, control goes to step S406. If the mounting/dismounting device 24 is the mounting/dismounting device 24e, then since it is not applicable to the workpiece 16b, control returns to step S404.

In step S406, it is confirmed by referring to the first workpiece type table 106a or the second workpiece type table 106b whether the process of the mounting/dismounting device 24 which transmits the loading request signal confirmed in step S402 is one process behind the process of the mounting/dismounting device 24 which transmits the unloading request signal confirmed in step S405 or not.

For example, if the unloading request signal is transmitted by the mounting/dismounting device 24b and the loading request signal is transmitted by the mounting/dismounting device 24g, then it can be confirmed by referring to the first workpiece type table 106a or the second workpiece type table 106b that the mounting/dismounting device 24b belongs to the process A and the mounting/dismounting device 24g belongs to the process B, and they are arranged in the sequence of processing workpieces 16. Therefore, the mounting/dismounting device 24b is determined to be the unloading source, and the mounting/dismounting device 24g is determined to be the loading destination. Control then goes to step S407. If the mounting/dismounting devices are not arranged in the sequence of processing workpieces 16, then control returns to step S404.

In step S407, the loading request signal and the unloading request signal for the respective unloading source and loading destination that have been determined are deleted respectively from the loading request data table 100 and the unloading request data table 102. Then, the blank rows are filled with subsequent loading and unloading request signals that are shifted upwardly. After several subsequent processing events have been performed as by storing the numbers of the mounting/dismounting devices 24 as the respective unloading source and loading destination that have been determined in a memory, control returns to step S402. If all the loading request signals are finally confirmed in step S402, the processing in step S6 shown in FIG. 6 is put to an end.

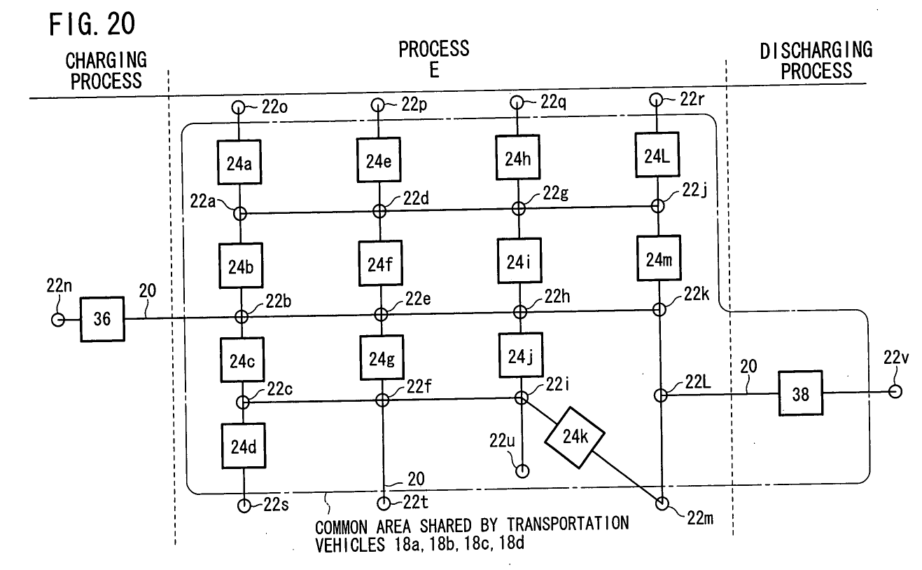

A modification of step S6 will be described below with reference to FIG. 20.

The modification of step S6 is of the same arrangement as the workpiece transportation system 10. According to the modification of step S6, the processing machines 14 ancillary to the mounting/dismounting devices 24a through 24m perform the single process (process E) on the workpieces 16. Specifically a workpiece 16 charged from the charging device 36 is loaded into either one of the mounting/dismounting devices 24a through 24m, processed, and then unloaded. The workpiece 16 is transported to the discharging device 38 without being loaded into the other mounting/dismounting devices 24.

With the modification of step S6, it is possible to determine an unloading source and a loading destination according to the above process, offering the same advantages.

With the modification of step S6, furthermore, since the number of mounting/dismounting devices 24 in the process E is large, all the transportation vehicles 18a through 18d may be assigned to a common area shared by all the mounting/dismounting devices 24a through 24m and the discharging device 38 for efficiently transporting workpieces 16.

According to the processing in step S6, as described above, unloading sources and loading destinations for the transportation vehicles 18 can be determined simply by referring to the loading request data table 100, the unloading request data table 102, the operation plan table 104, the first workpiece type table 106a, and the second workpiece type table 106b. Therefore, the workpiece transportation system can flexibly handle errors between times in which the processing machines 14 process the workpieces 16 and expected processing times, abrupt plan changes, and failures of the processing machines 14. The calculating burden on the main controller 12 may be small, and there is little danger of shutdown of the workpiece transportation system 10.

Even if mounting/dismounting devices 24 and processing machines 14 are added or removed, such additions and removals can be handled simply by updating certain data in the first workpiece type table 106a and the second workpiece type table 106b, without the need for changing an algorithm. Similarly, even if the number of transportation vehicles 18 is increased or reduced, it only suffices to increase or reduce the number of rows indicating the transportation vehicles 18 in the operation plan table 104.

The unit controllers 26 for controlling the mounting/dismounting devices 24 transmit loading request signals and unloading request signals for the workpieces 16, and the main controller 12 determines an unloading source and a loading destination each time it receives a request signal. Therefore, the main controller 12 can efficiently make decisions depending on the latest status at all times. In particular, because the loading request signals and unloading request signals that are recorded are processed in chronological order in steps S402 and S404 shown in FIG. 19, any particular mounting/dismounting device is prevented from waiting for a processing operation for a long period of time.

Even if the workpieces 16 are classified into a plurality of types and some processing machines 14 can only process certain types of workpieces 16, an appropriate loading destination can be determined by referring to the first workpiece type table 106a and the second workpiece type table 106b which correspond to the types of the workpieces 16.

Tables used in step S7 in the main routine shown in FIG. 6, i.e., the process of searching for a transportation path for a transportation vehicle 18, will be described in detail below with reference to FIGS. 21 through 23.

A branching device passage information table 110 shown in FIG. 21 has columns for recording a flag BFLG indicative of a recorded state of a traveling direction, a mark “S”/“G” indicative of a start point/a goal point, a direction “In_n” (_n indicates a branching device number) in which the transportation vehicle 18 enters, and a direction “Out_n” in which the transportation vehicle 18 travels, for each of the branching devices 22a through 22n.

The columns for recording the directions include individual columns for + directions with respect to directions Dx, Dy, Dz (+Dx, +Dy, +Dz, −Dx, −Dy, −Dz, see FIG. 2).

The flag BFLG is “0” when the corresponding branching device 22, charging device 36, or discharging device 38 is negligible, “1” when the traveling direction is being recorded, and “2” when the recording of the traveling direction is finished.

The branching device 22b will be described below. Since “S” is recorded in the column “START/GOAL”, the branching device 22b is a start point on the path. Since “Out22e” is recorded in the column “+Dx”, “Out22c” in the column “−Dy”, and “In22a” in the column “+Dy”, a transportation vehicle 18 can travel to the branching device 22e in the direction +Dx and to the branching device 22c in the direction −Dy. If both the branching devices 22a, 22b represent a start point as shown in FIG. 21, for example, then since the branching device 22b is present in the direction −Dy as viewed from the branching device 22a and the branching device 22a is present in the direction +Dy as viewed from the branching device 22b, “In22a” recorded in the column “+Dy” indicates that the actual start point is the mounting/dismounting device 24b (see FIG. 2).

The branching device 22e will be described below. Since “G” is recorded in the column “START/GOAL”, the branching device 22E is a goal point on the path. Since “In22d” is recorded in the column “+Dy” and “In22b” in the column “−Dx”, a transportation vehicle 18 can enter from the branching device 22d in the direction +Dy and from the branching device 22b in the direction −Dx. If both the branching devices 22e, 22f represent a goal point as shown in FIG. 21, for example, then since the branching device 22f is present in the direction −Dy as viewed from the branching device 22e and the branching device 22e is present in the direction +Dy as viewed from the branching device 22f, “Out22f” recorded in the column “−Dy” indicates that the actual goal point is the mounting/dismounting device 24g.

A branching device information table 112 shown in FIG. 22 is a table for recording positional coordinates, the numbers of branching devices 22 as connection destinations, the turn velocity, angular acceleration, and angular deceleration of the turn unit 78, and the directions of the respective connection destinations as directions +Dx, +Dy, +Dz, −Dx, −Dy, −Dz, for each of the branching devices 22a through 22v.

The branching device 22a will be described below. The positional coordinates are expressed as (xa, ya) in terms of orthogonal coordinates with respect to the directions Dx, Dy. The connection destinations are in three directions, i.e., the directions +Dx, +Dy, and −Dy, and indicate that the branching device 22d is connected in the direction +Dx, the branching device 22b is connected in the direction −Dy, and the branching device 22o is connected in the direction +Dy. The turn velocity, angular acceleration, and angular deceleration are ωa[°/SEC], ω[°/SEC²], and ωc[°/SEC²], respectively.

A path candidate data table 114 shown in FIG. 23 is a table for enumerating all combinations of path candidates indicated in the branching device passage information table 110, and stores paths as strings of branching devices 22 (written in the memory). “S” in a column represents a mounting/dismounting device 24 as a start point, and “G” in columns represents a mounting/dismounting device 24 as a goal point.

Each of the branching device passage information table 110, the branching device information table 112, and the path candidate data table 114 has a sufficient storage area capable of storing data when mounting/dismounting devices 24 and branching devices 22 are added and paths of transportation vehicles 18 are long.

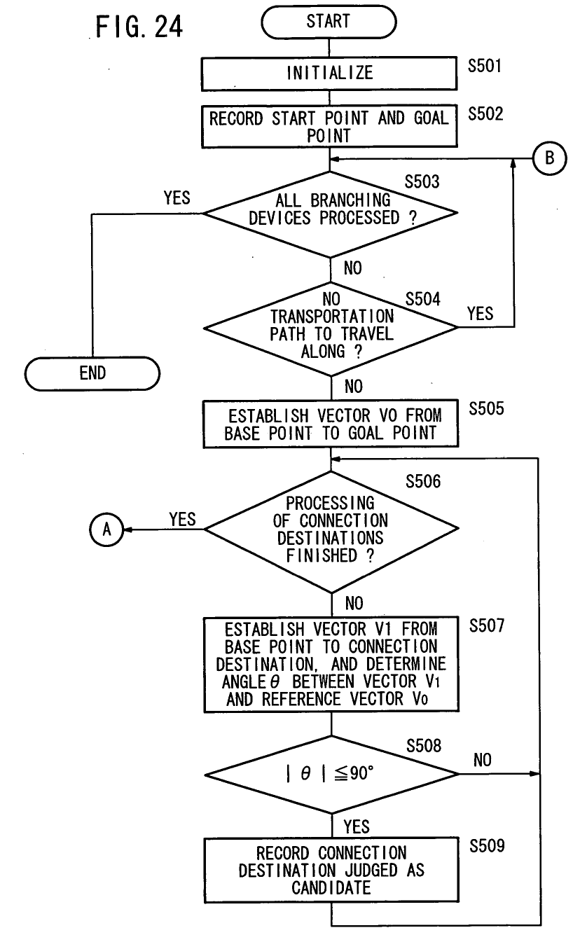

A process for searing for a transportation path for a transportation vehicle 18, which is executed in step S7 shown in FIG. 6, will be described below with reference to FIGS. 24 through 28.

The processing in step S7 basically determines vectors directed toward a goal point at major branching devices 22, selects connection destinations in a predetermined range from the vectors as paths in traveling directions, and records the selected connection destinations.

In step S501 shown in FIG. 24, the branching device passage information table 110 is initialized. That is, all the flags BFLG are reset to “0”, and the columns “DIRECTION”, “START”, and “GOAL” are left blank.

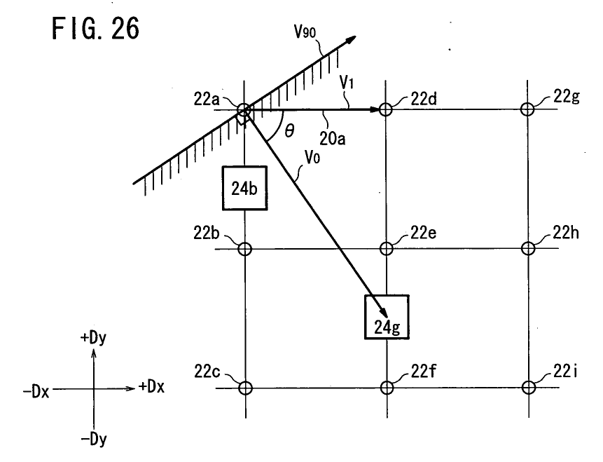

In step S502, start and goal points for the transportation vehicle 18 are recorded in the memory. As shown in FIG. 26, if the mounting/dismounting device 24b is a start point and the mounting/dismounting device 24g is a goal point, then the start point may be replaced with the branching devices 22a, 22b at the opposite ends of a transportation path 20 where the mounting/dismounting device 24b is present. “S” indicative of the start point is recorded in the corresponding column for the branching devices 22a, 22b in the branching device passage information table 110, and the respective flags BFLG are set to “1” indicating the recording in progress. “In22b” is recorded in the column “−Dy” for the branching device 22a, and “In22a” in the column “+Dy” for the branching device 22b, making it possible to understand that the true start point is present between the branching device 22a and the branching device 22b.

The goal point is replaced with the branching devices 22e, 22f at the opposite ends of a transportation path 20 where the mounting/dismounting device 24g is present. “G” indicative of the goal point is recorded in the corresponding column for the branching devices 22e, 22f in the branching device passage information table 110, and the respective flags BFLG are set to “2” indicating that the recording is finished.

In step S503, a branching device 22 for searching for a path is selected as a base point. Specifically, the branching device passage information table 110 is referred to for selecting a branching device 22 whose flag BFLG is “1” indicating the recording in progress. Then, control goes to step S504. If there is a plurality of branching devices 22 whose flag BFLG is “1”, then the uppermost one of them is selected. If all the flags BFLG are “0” or “2”, then since all the branching devices 22 that are required for searching have been processed, the processing in step S503 and step S7 is put to an end.

If the selected base point has no transportation path 20 to travel along in step S504, then the flag BFLG of that branching device 22 is set to “2”, and control returns to step S503.

In step S505, the vector stipulating unit 31c establishes a reference vector V₀ (see FIG. 12) extending from the base point (e.g., the branching device 22a) to the true goal point (the mounting/dismounting device 24g).

In step S506, the branching device information table 112 is referred to for checking connection destinations of the base point. The processing from next step S507 is performed on each of the connection destinations. However, if “−” is recorded in the column of connection destinations and the connection destinations are in an entry direction, then the processing therefor is skipped. If all connection destinations have been processed, then control goes to step S510.

For example, if the base point is the branching device 22a, then the connection destination in the direction −Dy is “22b”. Because it can be confirmed from the branching device passage information table 110 that “In22b” is in the direction −Dy of the branching device 22a, indicating that the transportation vehicle 18 enters, the processing therefor is skipped. The processing for the direction +Dy is also skipped as “−” is recorded with respect to the direction +Dy. Thus, with respect to the branching device 22a, the following processing may be performed on only the branching device 22d in the direction +Dx.

In step S507, a vector V₁ (see FIG. 26) is established from the base point to the connection destination. Specifically, if the branching device 22a is selected as the base point and the branching device 22d is selected as the connection destination, a transportation path 20a interconnecting the branching device 22a and the branching device 22d becomes a corresponding path. The branching device information table 112 is referred to, and the vector V₁ is determined by subtracting the positional coordinates (xa, ya) of the branching device 22a from the positional coordinates (xd, yd) of the branching device 22d.

The reference vector V₀ and the vector V₁ are converted into unit vectors, respectively, and their inner products are calculated to determine an angle θ therebetween.

In step S508, the value of the angle θ is confirmed. If the absolute value |θ| thereof is |θ|≦90°, then the connection destination is judged as a candidate for the traveling direction, and control goes to step S509. If |θ|>90°, control returns to step S506.

The above sequence is performed by the angular range path selecting unit 31d. The concept of the sequence will be described below. As shown in FIG. 26, a vector V₉₀ extending through the base point (the branching device 22a) perpendicularly to the reference vector V₀ is established, and a connection destination that is present on the side of the goal point (shaded side) as viewed from the vector V₉₀ is selected as the traveling direction. In this manner, the frequency with which backward paths are selected is greatly reduced, and the frequency with which roundabout paths or repetitive paths are selected is also greatly reduced.

The reference value for judging the absolute value |θ| is not limited to 90°, but may be smaller.

In step S509 shown in FIG. 24, the connection destination judged as a candidate for the traveling direction in step S508 is recorded in the branching device passage information table 110. Specifically, if the connection destination is the branching device 22d in the direction +Dx, then “Out22d” is recorded in the column “+Dx”, and “In22a” is recorded in the column “−Dx”. After the connection destination is recorded, control returns to step S506, repeating the processing therefrom.

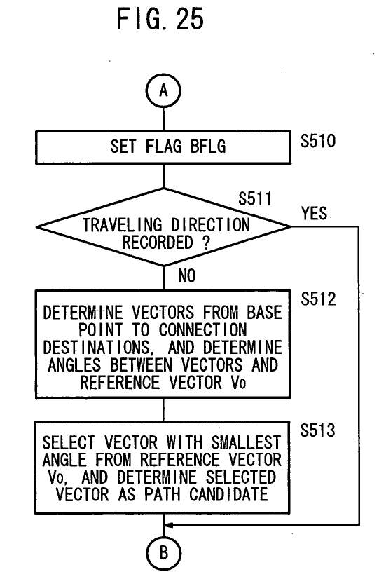

If the processing of the connection destinations is finished in step S506, then control goes to step S510 shown in FIG. 25, and the flag BFLG is set to “2” in the row for the branching device 22 that serves as the base point at the time in the branching device passage information table 110.

In step S511, it is confirmed whether at least one “Out_n” indicative of the traveling direction is recorded in that row or not. If “Out_n” is present, then control returns to step S503. If “Out_n” is not present, then control goes to step S512.

In step S512, all vectors from the base point to the connection destinations are determined, and angles formed between the determined vectors and the reference vector V₀ are calculated.

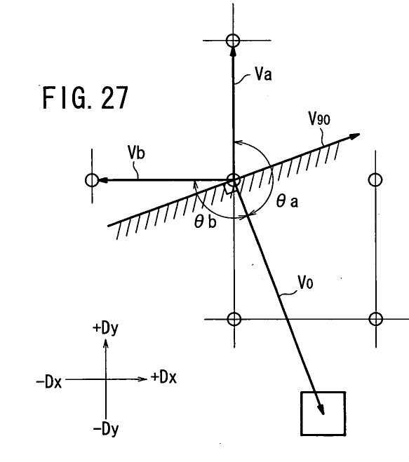

For example, as shown in FIG. 27, if there is not traveling path from the vector V₉₀ toward the goal point, vectors Va, Vb extending to two connection destinations on the opposite side are determined. Then, angles θa, θb between these vectors Va, Vb and the reference vector V₀ are calculated. At this time, as with step S506, the connection destination in the entry direction is neglected.

In step S513, the vector whose angle with respect to the reference vector V₀ is the smallest of the angles θa, θb is selected, and a connection destination corresponding to the selected vector is selected as a path candidate in the traveling direction. The selected connection destination is recorded in the branching device passage information table 110, as with step S509. Then, control returns to step S503.

Finally, if all the flags BFLG in the branching device passage information table 110 are “0” or “2” in step S503, then the processing in step S7 shown in FIG. 6 is put to an end. The branching devices where the flag BFLG is “0” are branching devices not related to the search for a transportation path, and the flag BFLG “0” indicates that unnecessary calculations have been eliminated with respect to those branching devices 22.

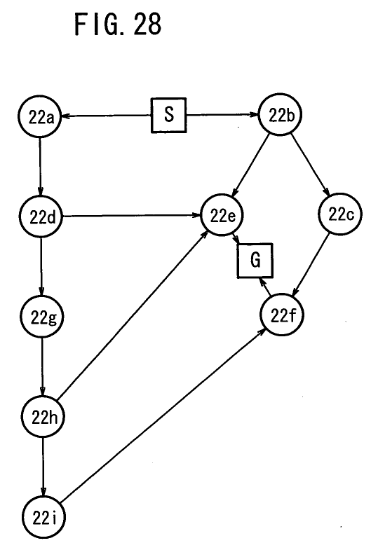

The candidate for the transportation path is recorded in the branching device passage information table 110. The candidate for the transportation path is conceptually illustrated in FIG. 28. Since the candidate for the transportation path is expressed in a complex fashion, it is divided into individual path candidates and the individual path candidates are enumerated by the processing in step S8 shown in FIG. 6.

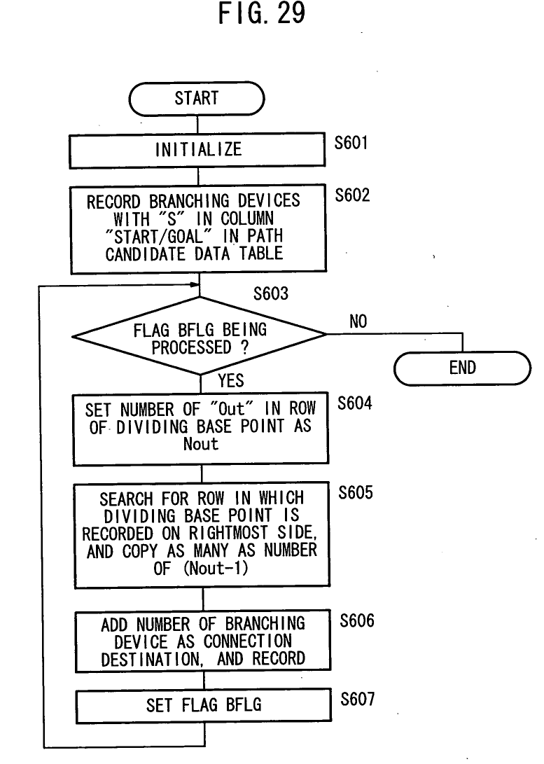

Step S8 in the main routine shown in FIG. 6, i.e., the process of enumerating path candidates, will be described in detail below with reference to FIGS. 29 through 31.

The processing in step S8 basically refers to the branching device passage information table 110, makes as many copies as the number of branches at each branching device 22, divides them, and enumerates and records all path candidates.

In step S601 shown in FIG. 29, all the flags BFLG in the branching device passage information table 110 are reset to “0”, and the path candidate data table 114 shown in FIG. 23 are initialized to make all cells thereof blank.

In step S602, those branching devices 22 where “S” is recorded in the column “START/GOAL” in the branching device passage information table 110 are searched for, and their flags BFLG are set to “1” indicating the processing in progress. Then, as many “S” are recorded in the column “PLACE 1” in upper rows of the path candidate data table 114 as the number of such branching devices 22, and the numbers of those branching devices 22 are recorded in the column “PLACE 2”.

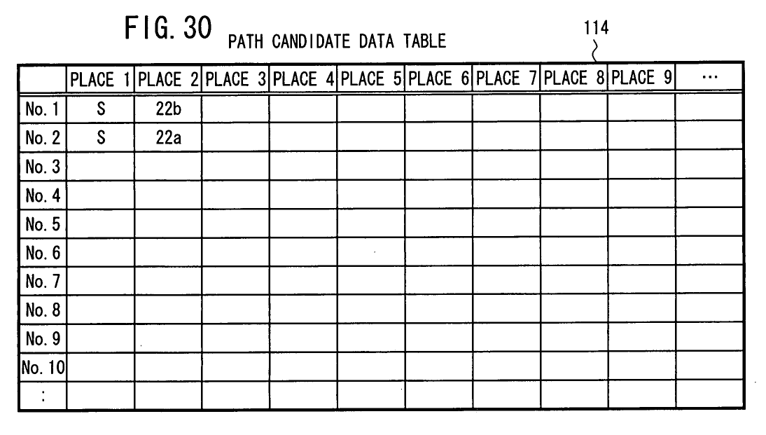

In the above example, the branching devices 22b, 22a are recorded in the column “PLACE 2” in the rows “No. 1”, “No. 2” of the path candidate data table 114 (see FIG. 30).

Then, in step S603, a branching device 22 serving as a dividing base point (hereinafter referred to as “dividing base point”) is selected. Specifically, the branching device passage information table 110 is referred to, and a branching device 22 where the flag BFLG is “1” indicating the processing in progress is selected. Then, control goes to step S604. If there is a plurality of branching devices 22 where the flag BFLG is “1”, then the uppermost one of them is selected. If all the flags BFLG are “0” or “2”, the processing in step S8 shown in FIG. 6 is put to an end.

In step S604, the number of recorded occurrences of “Out_n” in the row of the dividing base point selected in the branching device passage information table 110 is counted as Nₒᵤₜ.

In step S605, all rows where the dividing base point is recorded on the rightmost side at the time in the path candidate data table 114 are searched for, and those rows are copied as many as the number of (Nₒᵤₜ−1).

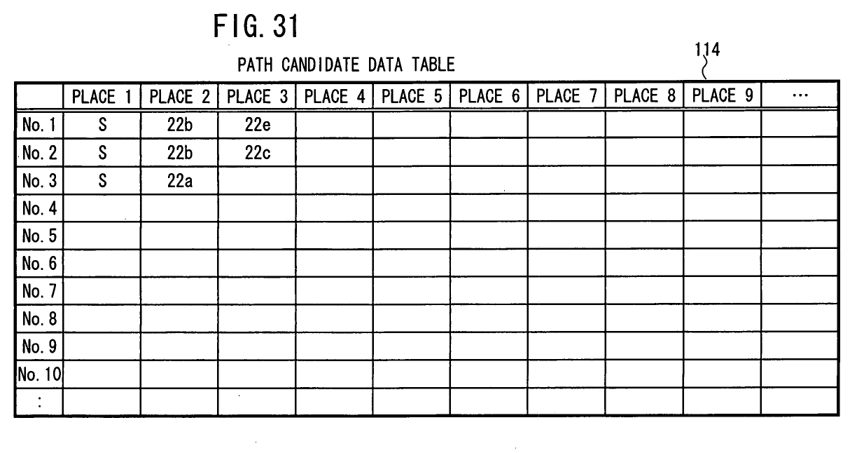

For example, if the dividing base point is the branching device 22b, then since “Out22e” and “Out22c” are recorded in the branching device passage information table 110 when it is referred to, Nₒᵤₜ=2 and Nₒᵤₜ−1=1. Therefore, the row “No. 1” in the path candidate data table 114 may be copied once. Now, in the path candidate data table 114 shown in FIG. 31, “S” is written in the column “PLACE 1” in the rows “No. 1” and “No. 2”, the branching device 22b is written in the column “PLACE 2” in the rows “No. 1” and “No. 2”, and the branching device 22a is written in the column “PLACE 2” in the row “No. 3”.

In step S606, the numbers of the branching devices 22 confirmed by “Out_n” in step S604 are added and recorded in the next column of rows which are copied from and to in step S605.

For example, “22e” and “22c” are recorded in the column “PLACE 3” in the rows “No. 1” and “No. 2”.

In step S607, the numbers of the branching devices 22 which are recorded in step S606 are referred to in the branching device passage information table 110. If “G” is recorded in the column “START/GOAL”, then “G” indicative of the end of the path is. recorded in the corresponding rows of the path candidate data table 114. If the column “START/GOAL” is blank, then the flags BFLG in the corresponding rows are set to “1”.

Since the processing of the dividing base point at the time is finished, the flag BFLG indicative of that dividing base point is set to “2” in the branching device passage information table 110. Thereafter, control returns to step S603.

If all the flags BFLG in the branching device passage information table 110 are finally “0” or “2” in step S603, then because all path candidates are enumerated in the path candidate data table 114, the processing in step S8 shown in FIG. 6 is put to an end.

In the processes of steps S7, S8 in the main routine shown in FIG. 6, as described above, since a connection destination that is present from the vector V₀ extending from the base point to the goal point within a predetermined angular range is selected as a traveling direction while searching for a path, the frequency with which backward paths are selected is greatly reduced, and the frequency with which roundabout paths or repetitive paths are selected is also greatly reduced.

By adjusting a given angle from the vector V₀, it is possible to adjust the number of selected path candidates.

Even if there is no connection destination in the predetermined angular range, a connection destination whose angle with respect to the vector V₀ is the smallest is selected as a traveling direction, thereby preventing a path from failing to be established while it is being searched for. Consequently, the data which have been produced so far are prevented from being unused, and the frequency with which roundabout paths are selected is minimized.

In step S7, a path is searched for with respect to each effective branching device 22. Therefore, the number of processing sequences may be equal to the number of branching devices 22 where the flag BFLG is “2” at the time the processing in step S7 is finished. As a result, not all combinations of final path candidates are required to be processed and judged. Furthermore, unnecessary processing events are eliminated because those branching devices 22 where the flag BFLG is “0” are not processed.

As a plurality of path candidates extending from the start point to the goal point are extracted, even if the shortest distance path or shortest time path is not effective in view of situations where other transportation vehicles 18 are located, other alternative paths are available.

Even when mounting/dismounting devices 24, processing machines 14, etc. are added or removed, the workpiece transportation system is made applicable simply by updating certain data in the branching device passage information table 110 and the branching device information table 112 without algorithm alterations.

The path candidate data table 114 can easily be used for subsequent processing because it represents the contents of the branching device passage information table 110 as the contents are divided into all combinations of path candidates.

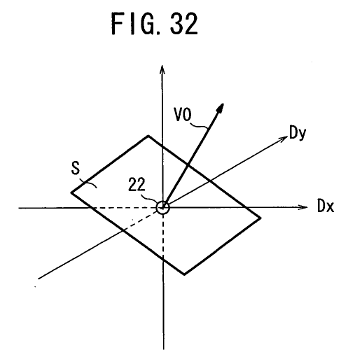

The network of transportation paths is applicable to not only a two-dimensional pattern, but also a three-dimensional warehouse or the like. In such a three-dimensional application, the processing in step S508 may be performed by defining a surface having a certain three-dimensional angle (e.g., 2π[sr]) with respect to the vector V₀ or a conical surface S, as shown in FIG. 32, and selecting a connection destination that is present in the range of the three-dimensional angle.

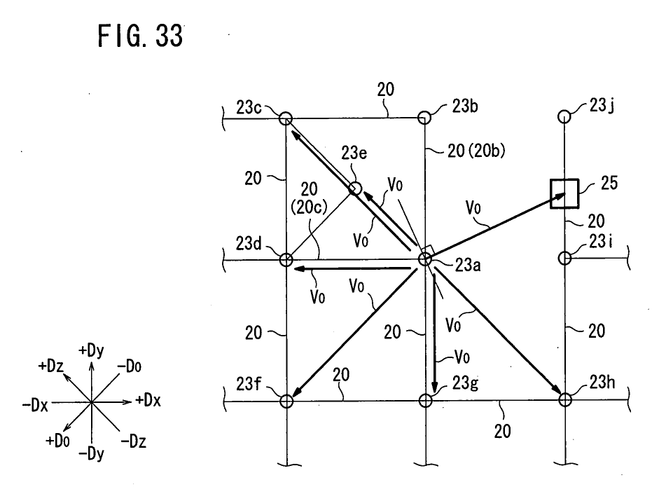

Step 9 in the main routine shown in FIG. 6, i.e., the process of correcting path candidates, will be described in detail below with reference to FIGS. 33 through 37.

It is assumed that steps S1 through S8 described above have been performed on a network of paths shown in FIG. 33 to determine path candidates. A procedure for correcting the path candidates thus determined will be described below.

As shown in FIG. 33, the network of paths is different from the network of paths shown in FIG. 2, and branching devices in FIG. 33 are denoted by the reference numeral 23, and a mounting/dismounting device in FIG. 33 is denoted by the reference numeral 25. The network of paths shown in FIG. 33 has ten branching devices 23a, 23b, 23c, 23d, 23e, 23f, 23g, 23h, 23i, 23j and a mounting/dismounting device 25 disposed intermediate between the branching devices 23i, 23j. The branching devices 23a through 23j are identical to the branching devices 22, and the mounting/dismounting device 25 is identical to the mounting/dismounting device 24 described above. The direction extending from the branching device 23e toward the branching device 23d is referred to as a direction +D₀, and the direction opposite thereto is referred to as a direction −D₀.

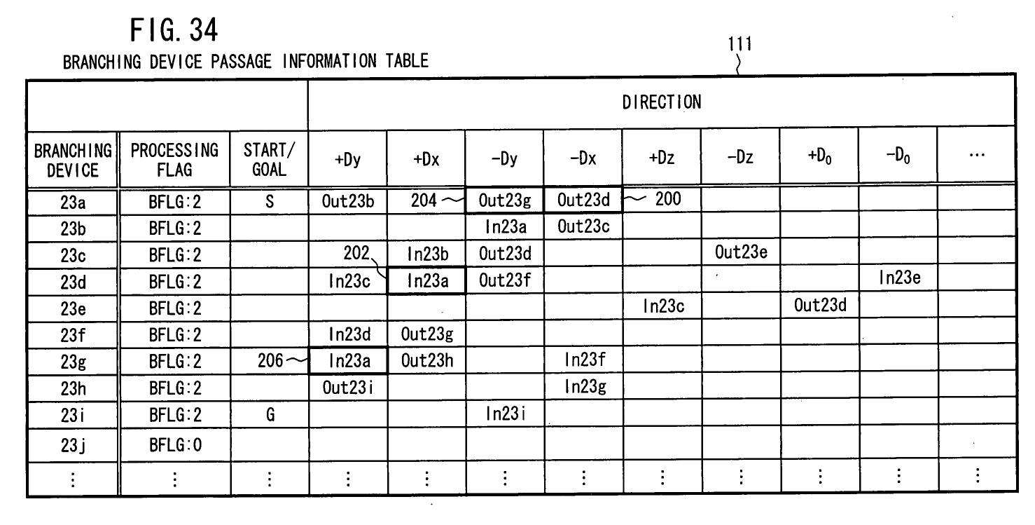

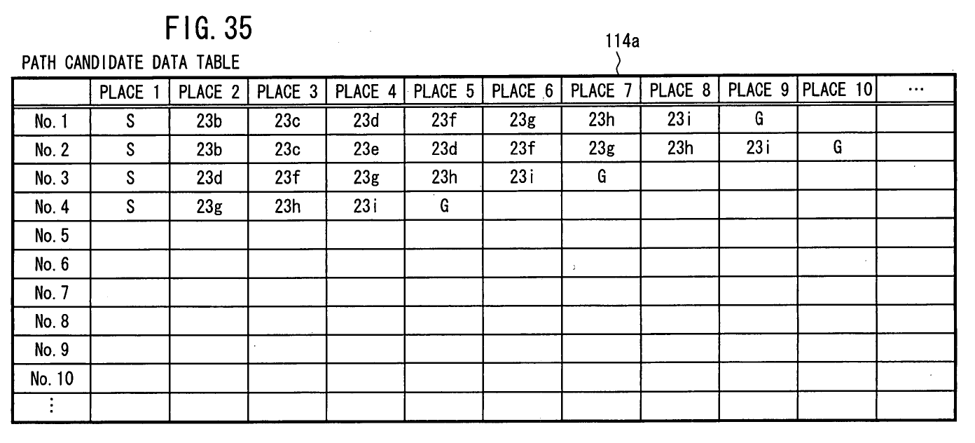

When a transportation vehicle 18 is present at the branching device 23a and is to move toward the mounting/dismounting device 25, path candidates are determined according to steps S1 through S8 shown in FIG. 6, producing a branching device passage information table 111 shown in FIG. 34 and a path candidate data table 114a shown in FIG. 35. It is assumed that nothing is recorded in columns 200, 202, 204, 206 of the branching device passage information table 111 shown in FIG. 34 at this time, and that nothing is recorded in rows “No. 3” and “No. 4” shown in FIG. 35 at this time.

The branching device passage information table 111 corresponds to the branching device passage information table 110 (see FIG. 21), and is practically of the same format as the branching device passage information table 110. The branching device passage information table 111 has columns for recording therein information as to entry/travel with respect to the directions +D₀, −D₀. The branching device passage information table 111 records therein the directions in which the transportation vehicle 18 enters and travels with respect to each branching device 23.

The path candidate data table 114a corresponds to the path candidate data table 114 (see FIG. 23), and is practically of the same format as the path candidate data table 114. The path candidate data table 114a records therein path candidates provided by developing the information recorded in the branching device passage information table 111.

In the path candidate data table 114a, a path candidate indicated by “No. 1” represents a path starting from the branching device 23a and extending successively through the branching devices 23b, 23c, 23d, 23f, 23g, 23h, and 23i. A path candidate indicated by “No. 2” represents a path starting from the branching device 23a and extending successively through the branching devices 23b, 23c, 23e, 23d, 23f, 23g, 23h, and 23i. As can be seen from FIGS. 33 and 35, each of these path candidates is a roundabout path. Specifically, a reference vector V₀ extending from the branching device 23a as a start point to the mounting/dismounting device 25 as a goal point is established, and a transportation path that is present in an angular range of ±90° from the reference vector V₀ is only the transportation path 20b leading to the branching device 23b. Therefore, the transportation path 20b is selected, and as a result, such roundabout paths are established.

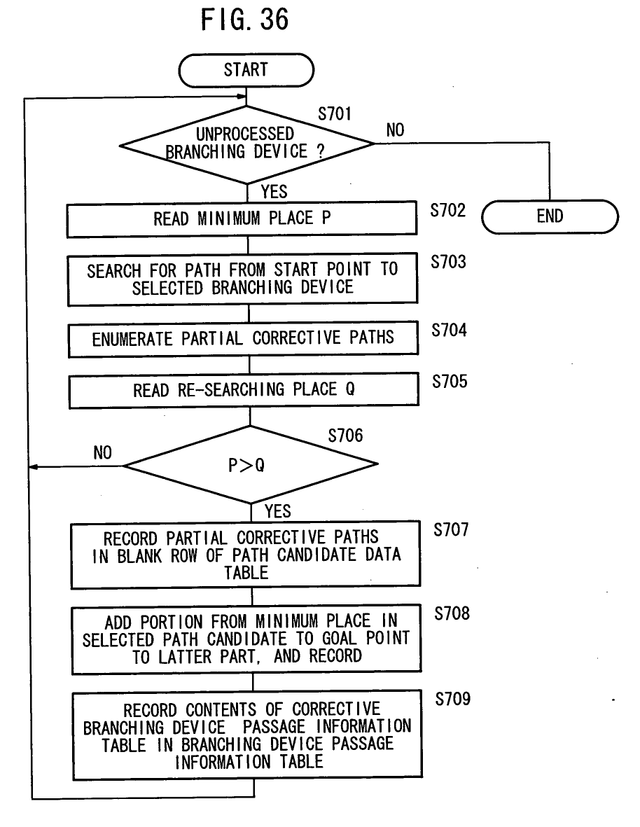

In step S701 shown in FIG. 36, the unprocessed branching devices 23 that are recorded in the path candidate data table 114a are selected (paths being selected). If all the branching devices 23 that are recorded in the path candidate data table 114a have been processed, then the processing in step S9 shown in FIG. 6 is put to an end. If there are any branching devices 23 that are unprocessed, then control goes to step S702.

In step S702, the place of a branching device 23 selected in the path candidate data table 114a is read and stored as a minimum place P (P≧2). For example, since the branching device 23c is recorded in the column “PLACE 3”, the minimum place P thereof is P=3. Since the branching device 23d is recorded in the columns “PLACE 4” and “PLACE 5”, its minimum place P is set to P=4 based on the minimum “PLACE 4”. Similarly, the minimum place P of the branching device 23f is P=5, and the minimum place P of the branching device 23g is P=6.

A row which serves as a basis for the minimum place P is stored as a selected path candidate. For example, since the minimum place P of the branching device 23d is set to P=4 by the row “No. 1” in the path candidate data table 114a, the row “No. 1” is stored as a selected path candidate. Since a plurality of selected path candidates can be present, all of such plural selected path candidates are stored if they are present. Alternatively, a selected path candidate whose overall length is the shortest may be selected.

Rows other than selected path candidates may be regarded as being invalid. This is because it is apparent that rows that are not selected path candidates are roundabout path candidates compared with selected path candidates and hence they are not necessary in a process for searching for shorter corrective paths. Thus, in the path candidate data table 114a shown in FIG. 35, the row “No. 2” is invalid and only the row “No. 1” may be processed. Consequently, any processing on the branching device 23e included in only the row “No. 2” may be dispensed with.

In step S703, a path extending from the branching device 23a as a start point to the selected branching device 23, i.e., a partial corrective path, is searched for. The searching process is basically the same as the process shown in FIGS. 24 and 25. However, a corrective branching device passage information table (not shown) which is of the same format as the branching device passage information table 111 (see FIG. 34) is used instead of the branching device passage information table 111. In the corrective branching device passage information table, “S” is recorded in the column “START/GOAL” for the branching device 23a, and “G” is recorded in the column “START/GOAL” for the selected branching device.

For example, when the branching device 23d is selected, a reference vector V₀ extending from the branching device 23a as a start point to the branching device 23d is established, and the transportation path 20c (corrective transportation path) that is present in an angular range of +90° from the reference vector V₀ is searched for. Since a connection destination of the transportation path 20c that is searched for is the selected branching device 23d itself, the searching process is put to an end at this time. The search result is recorded as “Out23d” in the column “−Dx” for the branching device 23a in the corrective branching device passage information table, and as “In23a” in the column “+Dx” for the branching device 23d in the corrective branching device passage information table.

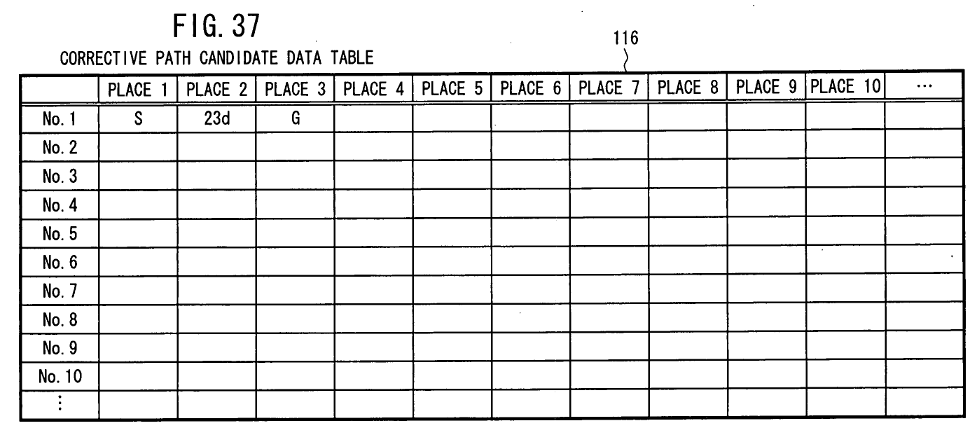

In step S704, partial corrective paths are enumerated based on the corrective branching device passage information table thus generated. The enumerating process is basically the same as the process shown in FIG. 29. However, a corrective path candidate data table 116 (see FIG. 37) which is of the same format as the path candidate data table 114a (see FIG. 35) is used instead of the path candidate data table 114a.

In step S705, a column where the selected branching device 23 is read as a re-search place Q (Q≧2) from the corrective path candidate data table 116 that is generated.

In the example shown in FIG. 37, partial corrective paths are determined with respect to the branching device 23d, and the re-search place Q at this time is Q=2. With respect to the branching devices 23b, 23g, it is clear that a partial corrective path is a single path in one interval from the branching device 23a (see FIG. 33), and the re-search place Q is Q=2.

With respect to the branching device 23c, three partial corrective paths are determined. Specifically, a first path extends successively through the branching devices 23a, 23b, 23c; a second path through the branching devices 23a, 23d, 23c; and a third path through the branching devices 23a, 23d, 23e, 23c. If a plurality of partial corrective paths are present, as described above, then the shortest one is selected and applied. In this case, the re-search place Q is Q=3.

In step S706, the minimum place P and the re-search place Q are compared with each other. If the minimum place P is smaller than or equal to the re-search place Q, then control returns to step S701. If the minimum place P is greater than the re-search place Q, then control goes to step S707.

In the example shown in FIG. 33, when the branching device 23b or 23c is selected, since the minimum place P is equal to the re-search place Q, control returns to step S701, and when the branching device 23d or 23g is selected, control goes to step S707.

In step S707, the portion of the partial corrective path exclusive of the mark “G” indicative of the goal point in the corrective path candidate data table 116 (see FIG. 37) is recorded in a blank row of the path candidate data table 114a. At this time, it is copied as many times as the number of selected path candidates selected in step S702 and recorded. Specifically, in the example shown in FIG. 37, “S” and “23d” are copied to the row “No. 3” of the path candidate data table 114a.

In step S708, the portion of the selected path candidate which ranges from the minimum place P to the mark “G” indicative of the goal point is added to the latter part of the portion copied in step S707, and the result is stored. If there is a plurality of selected path candidates, the same process is performed on all the selected path candidates.

The row “No. 3” of the path candidate data table 114a shown in FIG. 35 represents an example in which the places 5 through 9 in the row “No. 1” as a selected path candidate, i.e., the symbols “23f” through “G”, are added to the latter part of the partial corrective path (also see FIG. 37) determined with respect to the branching device 23d. The row “No. 4” represents an example in which the places 7 through 9 in the row “No. 1” as a selected path candidate, i.e., the symbols “23h” through “G”, are added to the latter part of the partial corrective path determined with respect to the branching device 23g.

In step S709, the contents recorded in the corrective branching device passage information table are added and recorded in the branching device passage information table 111 shown in FIG. 34. Specifically, columns 200, 202 are recorded as partial corrective paths directed from the branching device 23a toward the branching device 23d, and columns 204, 206 are recorded as partial corrective paths directed from the branching device 23a toward the branching device 23g. Thereafter, control returns to step S301.

According to the processing in step S9 in the main routine shown in FIG. 6, the length of a partial corrective path with respect to each branching device 23 included in a prepared path candidate, i.e., a re-search place Q, is determined, and it can be determined whether the path candidate is a roundabout path or not based on the magnitude relationship between the minimum place P of the branching device 23 in the path candidate and the re-search place Q. If the path candidate is a roundabout path, then since the forward path of the selected branching device 23 is a roundabout path portion, it is replaced with the partial corrective path, resulting in a corrective path that is shorter than the original path candidate.

As a result, rows “No. 3” and “No. 4” which are shorter than the initially established rows “No. 1” and “No. 2” can be obtained in the path candidate data table 114a.

In the above embodiment, a partial corrective path is searched for with respect to a selected path candidate based on the positional relationship between the branching devices 23 in the selected path candidate and the starting point. However, a partial corrective path may be searched for between any desired two branching devices in a selected path candidate.

Tables used in step S10 in the main routine shown in FIG. 6, i.e., the process of calculating transportation times for respective path candidates, will be described in detail below with reference to FIGS. 38 through 42.

A transportation path information table 113 shown in FIG. 38 is a table for recording therein the numbers of branching devices 22 as connection destinations, the speeds, accelerations, and decelerations at which transportation vehicles 18 are transported, with respect to respective transportation paths 20. For example, the transportation path information table 113 indicates that the branching devices 22a, 22b are interconnected by the transportation path 20a.

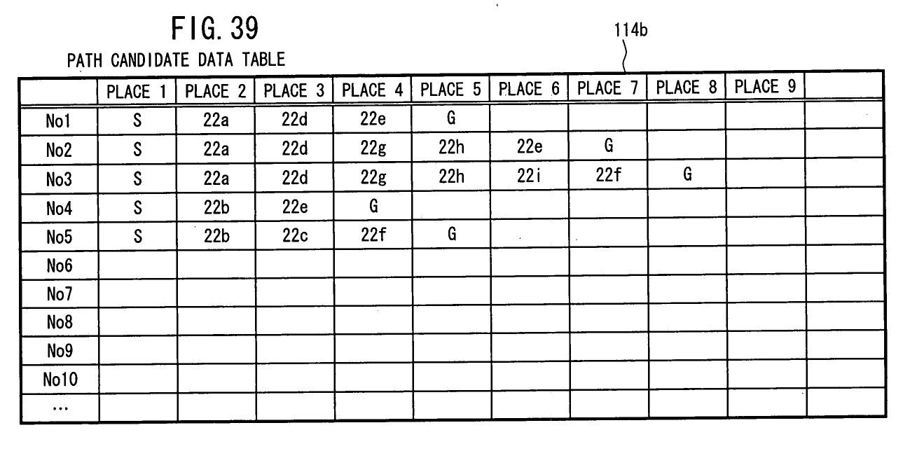

A path candidate data table 114b shown in FIG. 39 corresponds to the path candidate data table 114 (see FIG. 23) or the path candidate data table 114a (see FIG. 35), and is practically of the same format as these tables. For illustrative purposes, the path candidate data table 114b has recorded contents that are different from those of the path candidate data table 114.

A path candidate time data table 115 shown in FIG. 40 has places each divided into columns “TRAVELING TIME”, “TURNING TIME”, and “STANDBY TIME”. The traveling time is a time to travel along a transportation path 20, and the turning time is a time which is required for the turn unit 78 of the branching device 22 to make a turn. Both the traveling time and the turning time are a time in motion (passage time), and are distinguished from the standby time. The path candidate time data table 115 also has columns “TOTAL TRAVELING TIME”, “TOTAL TURNING TIME”, “TOTAL STANDBY TIME” for recording therein the sums of traveling times, turning times, and standby times, and also a column “TRANSPORTATION TIME” for recording therein the sum of those total times. The “PLACES” in the path candidate time data table 115 are of values that are “1” smaller than the “PLACES” by “1” in the path candidate data table 114.

A branching device reservation data table 120 shown in FIG. 41 is a table for reserving transportation vehicles 18 as they make an entry action to enter respective branching devices 22 and a traveling action to leave respective branching devices 22. Each time an action is finished, its reservation is eliminated.

The branching device 22d will be described below. Since “18c” is recorded in only the leftmost column “PLACE 1”, the transportation vehicle 18c is reserved for its action to wait at the branching device 22d and travel to either one of the branching devices 22.

The branching device 22b will be described below. Since “18a” is recorded in the columns “PLACE 1” and “PLACE 2”, a transportation vehicle 18 is reserved for its action to enter from either one of the branching devices 22 and travel to another one of the branching devices 22.

A branching device time management table 122 shown in FIG. 42 is a table which is of the same format as the branching device reservation data table 120, and records reserved times as times from the present time in columns corresponding to the columns of the branching device reservation data table 120.

For example, it can be seen with respect to the branching device 22b that the transportation vehicle 18a enters into the branching device 22b 10 [SEC] later and passes through the branching device 22b 15 [SEC] later, whereupon the branching device 22b is released from use.

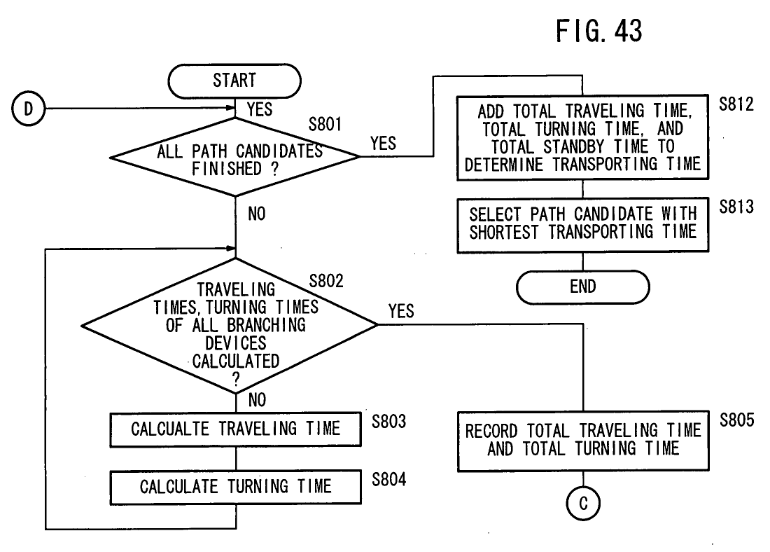

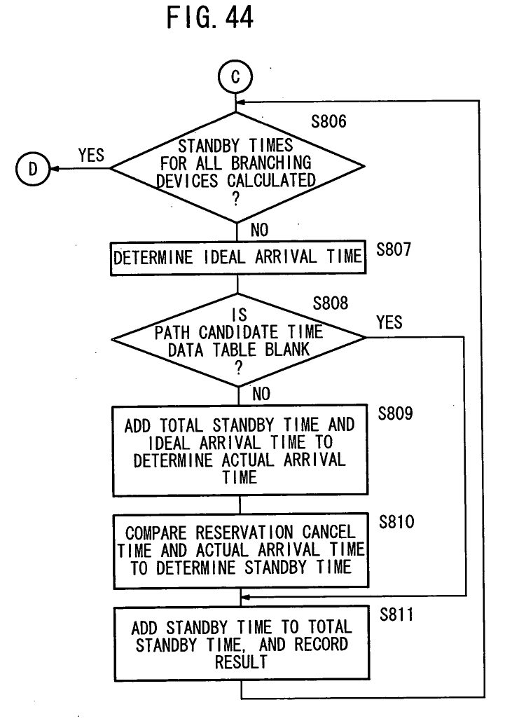

A procedure for calculating transportation times for respective path candidates in step S10 will be described below with reference to FIGS. 43 and 44.

The processing in step S10 basically refers to tables for reserved situations of branching devices 22 while a transportation vehicle 18 is being transported, determines a standby time in which the transportation vehicle 18 needs to wait, and totals the standby time and a time required for the transportation vehicle 18 to move, thus determining an actual transportation time.

The above procedure is carried out by selecting path candidates successively from the uppermost row in the path candidate data table 114b shown in FIG. 39 in step S801 and then executing steps S802 through S811 with respect to each of the selected path candidates. After all the path candidates are processed, control goes to step S812 for subsequent processing.

In step S802, the path candidate data table 114b is referred to for selecting a branching device 22 to pass through, in the rightward direction successively from the place 2. A process of calculating a traveling time in step S803 and a process of calculating a turning time in step S804 are then effected on the selected branching device 22. These processes are carried out by the passage time calculating unit 31e. Traveling times and turning times for all the branching devices 22 with respect to each of the path candidates are calculated, and then totaled. The totals of the traveling times and turning times are recorded as a total traveling time and a total turning time in the column “TOTAL TRAVELING TIME/TOTAL TURNING TIME” of the path candidate time data table 115 (step S805). Thereafter, control goes to step S806.

Specifically, in step S803, a traveling time required to pass through the transportation path 20 between the selected branching device 22 and the branching device 22 that is one place before the selected branching device 22 is calculated.

For example, in the column “PLACE 3” of the path candidate “No. 1” in the path candidate data table 114b, the number of the branching device 22 is “22d”. In the column “PLACE 2” which is one place before the column “PLACE 3”, the number of the branching device 22 is “22a”. By referring to the transportation path information table 113 shown in FIG. 38, it can be seen that the transportation path 20a is present between the branching device 22a and the branching device 22d. A traveling time required to move between the branching device 22a and the branching device 22d is calculated from the length of the transportation path 20a and the speed, acceleration, and deceleration.

If the column of the number of a branching device 22 in the path candidate data table 114b shown in FIG. 39 represents “G” or the column “PLACE 2” is concerned, then the distance between the goal point or the start point and the branching device 22 is determined, and a traveling time is calculated by replacing the “length” among the data in the transportation path information table 113 with the determined distance.

Traveling times thus determined are recorded successively from the left in the columns “TRAVELING TIME” of the path candidate time data table 115 shown in FIG. 40.

Then, in step S804, the turning time of the turn unit 78 of the selected branching device 22 is calculated.

For example, with respect to the column “PLACE 2” of the path candidate “No. 1” in the path candidate data table 114b shown in FIG. 39, the turning time of the branching device 22a is calculated. Specifically, the branching device information table 112 shown in FIG. 22 is referred to, and a turning angle is determined from the directions in which the transportation vehicle 18 enters into and travels through the branching device 22a and the positional coordinates of branching devices 22 as respective connection destinations and the branching device 22a. Then, a turning time is calculated from the turning angle and the turning speed, angular acceleration, and angular deceleration in the columns of the branching device 22a.

A turning angle may be determined in advance based on combinations of the directions +Dx, +Dy, +Dz, −Dx, −Dy, −Dz from the column “CONNECTING DIRECTION” in the branching device information table 112. In such a case, for a straight movement such as a movement from the direction +Dx to the direction −Dx, no turning motion is required and hence the calculating process may be dispensed with, with the time required for turning being set to “0”. For calculating a tuning time, not only the time in which the turn unit 78 turns may be calculated, but also the time of a transition time in which the transportation vehicle 18 is shifted between the transportation path 20 and the branching device 22 may be added.

Turning times thus determined are recorded successively from the left in the columns “TURNING TIME” of the path candidate time data table 115 shown in FIG. 40.

After the recording, control returns to step S802, and the same process is repeated on a next path candidate.

The processing in steps S806 through S810 (see FIG. 44) for determining a standby time will be described below. This processing is carried out by the standby time calculating unit 31f.

In step S806, the path candidate data table 114b shown in FIG. 39 is referred to for selecting branching devices 22 which pass successively to the right from the place 2. Then, a process of calculating a total standby time in steps S807 through S811 is performed on the selected branching devices 22. After the total standby time is calculated for all the branching devices 22 for each of the path candidates, control goes back to step S801, and a next path candidate is processed.

Specifically, in step S807, the traveling time for the column selected in the path candidate time data table 115 is added to the total of traveling times and turning times that are recorded in places (leftward) before the selected column, producing an ideal arrival time. The ideal arrival time represents a time at which the transportation vehicle 18 arrives at the branching device 22 in the column if no failure occurs.

For example, if the path candidate is “No. 1” and the place is “PLACE 2”, then it can be seen by referring to the path candidate time data table 115 that the ideal arrival time is 7+5+20=32 [SEC] and the transportation vehicle 18 will arrive at the branching device 22d 32 [SEC] after.

Since a turning action is an action that is made after arrival, a turning time in the column is not added.

In step S808, the number of a branching device 22 in the path candidate data table 114b shown in FIG. 39 is confirmed from the column corresponding to the path candidate time data table 115 shown in FIG. 40. The confirmed branching device 22 is then referred to in the branching device time management table 122 shown in FIG. 42, and a reservation canceling time at which the reservation of the branching device 22 is canceled is checked, after which control goes to step S809. The reservation canceling time is obtained by reading a numerical value in the rightmost column, which is not blank, of the branching device time management table 122. If the corresponding column of the path candidate time data table 115 is blank, then the standby time at the branching device 22 is set to “0”, and control goes to step S811.

In step S809, the numerical value in the column “TOTAL STANDBY TIME” of the path candidate time data table 115 and the ideal arrival time are added into an actual arrival time (arrival time). The numerical value in the column “TOTAL STANDBY TIME” may be referred to at the present time. If the column “TOTAL STANDBY TIME” is blank, then the numerical value in that column is regarded as “0”.

In step S810, the reservation canceling time and the actual arrival time are compared with each other to determine a standby time. Specifically, if the reservation canceling time is smaller than the actual arrival time, then since the reservation of the branching device 22 has been canceled prior to the actual arrival time, the standby time is set to “0”. If the reservation canceling time is greater than the actual arrival time, then the difference therebetween is set to the standby time.

In the above example, if the path candidate is “No. 1” and the place is “PLACE 2”, then since the actual arrival time in which the transportation vehicle 18 arrives at the branching device 22d is 32 [SEC], and the reservation canceling time for the branching device 22d is 60 [SEC] by referring to the branching device time management table 122, the standby time is given as 60−32=28 [SEC].

In step S811, the determined standby time is integrated and recorded in the column “TOTAL STANDBY TIME” of the path candidate time data table 115. Specifically, if the column “TOTAL STANDBY TIME” is blank, then the determined standby time is directly recorded. If a standby time has been recorded in the column “TOTAL STANDBY TIME”, then the determined standby time is added to the recorded standby time, and the sum is recorded. Values which are not integrated are directly recorded in the columns “STANDBY TIME” of the respective places for use in other applications. The integration refers to an accumulative addition.

After the recording, control returns to step S806, and the same process is repeated on a next path candidate.

After the processing in steps S801 through S805 for determining a traveling time and the processing in steps S806 through S811 for determining a standby time, the “TOTAL TRAVELING TIME”, the “TOTAL TURNING TIME”, and the “TOTAL STANDBY TIME” are added to determine a transportation time with respect to each of the path candidates in the path candidate time data table 115 shown in FIG. 40 by the function of the transportation time totaling unit 31g in step S812. The determined transportation time is recorded in the column “TRANSPORTATION TIME”.

In step S813, the shortest one of the times recorded in the column “TRANSPORTATION TIME” of the path candidate time data table 115 is selected and determined as a path for the transportation vehicle 18. The processing in step S10 shown in FIG. 6 is put to an end.

According to the processing in step S10 in the main routine shown in FIG. 6, as described above, since the time at which the reservation is canceled is recorded for each branching device 22, a standby time can be calculated by comparison with the actual arrival time at which the transportation vehicle 18 arrives at the branching device 22. At this time, the actual standby time can accurately be calculated since it is determined by totaling the traveling time, the turning time, and the standby time prior thereto.

The traveling time can accurately be determined as it is calculated based on the length and speed, and, in addition, the acceleration and deceleration at the transportation path 20.

Similarly, the turning time can accurately be determined as it is calculated based on the turning angle and angular velocity, and, in addition, the angular acceleration and angular deceleration at the branching device 22.

The length, speed, acceleration, and deceleration at the transportation path 20 and the turning angle, angular velocity, angular acceleration, angular deceleration at the branching device 22 are recorded as numerical values that are independent with respect to each transportation path 20 or each branching device 22. Therefore, even if these devices are added with different specifications or the capabilities of these devices are changed, the numerical values may individually updated to adapt themselves.

Since transportation times are determined with respect to a plurality of paths and the shortest one of the determined transportation times is selected, a transportation vehicle 18 with its path being in the process of being established can be brought quickly to its goal point in view of the movement of other transportation vehicles 18.

Even when mounting/dismounting devices 24, processing machines 14, etc. are added or removed, the workpiece transportation system is made applicable simply by updating certain data in the branching device information table 112, the transportation path information table 113, the path candidate data table 114b, the path candidate time data table 115, the branching device reservation data table 120, and the branching device time management table 122 without algorithm alterations.

Step S11 in the main routine shown in FIG. 6, i.e., the process of reserving branching devices 22 and the process of moving a transportation vehicle 18 according to the reservations, will be described in detail below with reference to FIGS. 40 through 48.

The processing in step S11 basically records times for a transportation vehicle 18 to reserve branching devices 22, together with the identification number of transportation vehicle 18, in the branching device reservation data table 120, for thereby preventing the transportation vehicle 18 from conflicting other transportation vehicles.

In the following description, it is assumed that when the transportation vehicle 18b is to receive a workpiece 16 unloaded from the mounting/dismounting device 24b and to load the workpiece 16 into the mounting/dismounting device 24g, paths represented by “No. 1” in the path candidate data table 114b shown in FIG. 39 and the path candidate time data table 115 shown in FIG. 40, i.e., paths extending successively through the mounting/dismounting device 24b (indicated by “S” in FIG. 39), the branching device 22a, the branching device 22d, the branching device 22e, and the mounting/dismounting device 24g (indicated by “G” in FIG. 39).

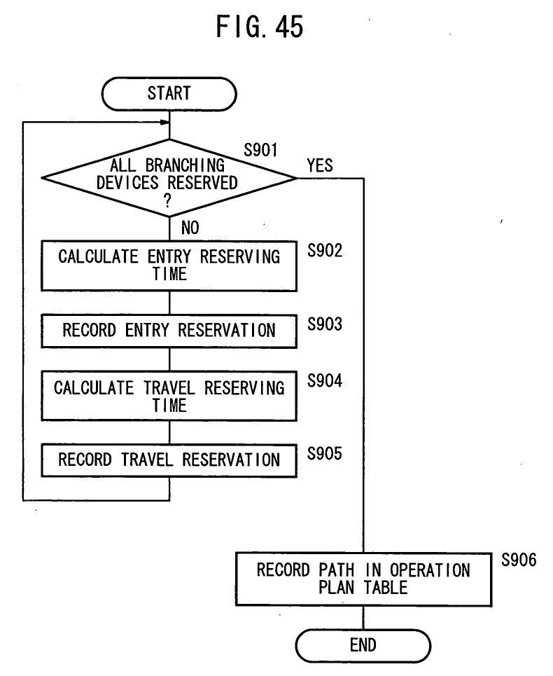

In step S901 shown in FIG. 45, a branching device 22 is selected. Specifically, the path candidate data table 114b shown in FIG. 39 is referred to for selecting a branching device 22 to pass through, in the rightward direction successively from the place 2. A reserving process is then effected on the selected branching device 22 in steps S902 through S905. All branching devices 22 are reserved for each path candidate, after which control goes to step S906.

Specifically, in step S902, an entry reserving time for the selected branching device 22 is calculated. The entry reserving time is determined by confirming a place corresponding to the selected branching device 22 in the path candidate time data table 115, and adding the traveling time and the standby time in that place, and traveling times, standby times, and turning times in all places prior to that place.

Since a turning action is an action that is made after arrival, a turning time in the column is not added.

In step S903, an entry reservation is recorded. This recording serves to reserve the entry of a transportation vehicle 18 into the branching device 22. Specifically, the entry reserving time is recorded in a left-end column of blank columns in the row that is indicated by the number of the selected branching device 22 in the branching device time management table 122 shown in FIG. 42. Furthermore, the number (identification number) of the transportation vehicle 18 is recorded in a left-end column of blank columns in the row that is indicated by the number of the selected branching device 22 in the branching device reservation data table 120 shown in FIG. 41.

In step S904, a travel reserving time for the selected branching device 22 is calculated. The travel reserving time is determined by adding the turning time at the branching device 22 to the entry reserving time determined in step S902.

For calculating the travel reserving time, not only the time in which the turn unit 78 turns may be calculated, but also the time of a transition time in which the transportation vehicle 18 is shifted between the transportation path 20 and the branching device 22 may be added.

In step S905, a travel reservation is recorded. This recording serves to reserve the leaving of a transportation vehicle 18 from the branching device 22. Specifically, as with step S203, the travel reserving time is recorded by recording the number of the transportation vehicle 18 and the travel reserving time in the branching device reservation data table 120 shown in FIG. 41 and the branching device time management table 122 shown in FIG. 42.

By recording the entry reservation and the travel reservation in the branching device reservation data table 120 and the branching device time management table 122, the transportation vehicle 18 secures the right to exclusively use the branching device 22 within the reserving times, and prevents other transportation vehicles 18 from using the branching device 22.

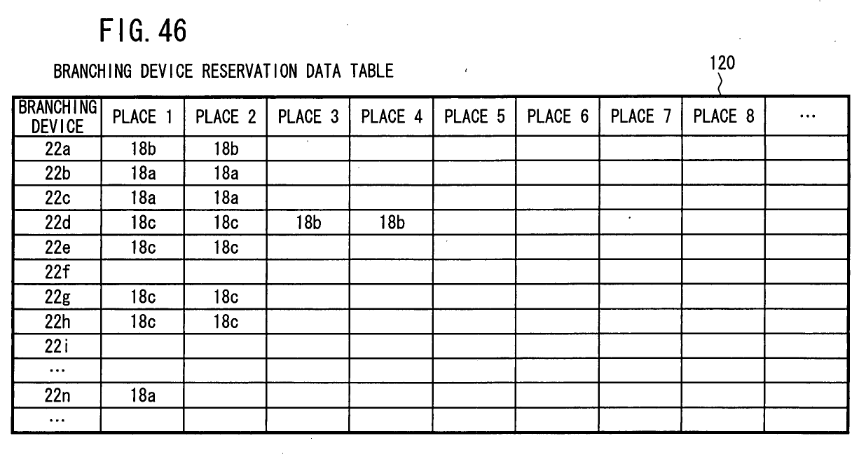

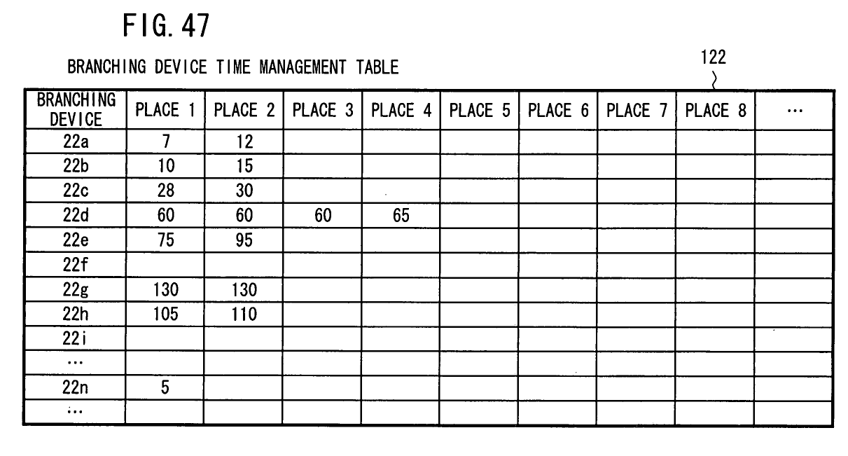

A branching device reservation data table 120 shown in FIG. 46 and a branching device time management table 122 shown in FIG. 47 illustrate an example in which entry reserving times and travel reserving times are reserved with respect to the column “PLACE 3” for the path candidate “No. 1” (see FIG. 39), i.e., the branching device 22d. The number “18b” of a transportation vehicle 18 is recorded in “PLACE 3” and “PLACE 4” in the row of the branching device 22d of the branching device reservation data table 120. Furthermore, an entry reserving time “60” and a travel reserving time “65” are recorded in the corresponding columns in the row of the branching device 22d of the branching device time management table 122. In this example, since transition times in which the transportation vehicles 18b, 18c enter from the transportation path 20 into and travel through the branching device 22d are not taken into account, all reservation times in “PLACE 1” through “PLACE 2” are “60”. However, if such transition times are not negligible, then a certain time is added.

After the above reservations are made, control returns to step S201, and a next branching device 22 is selected and similarly processed.

All the branching devices 22 for path candidates are reserved, and a path is recorded in the row of a given transportation vehicle 18 of the operation plan table 104, whereupon step S11 is finished. Then, control goes to step S12 in the main routine shown in FIG. 6 for waiting for the condition of a next calculation.

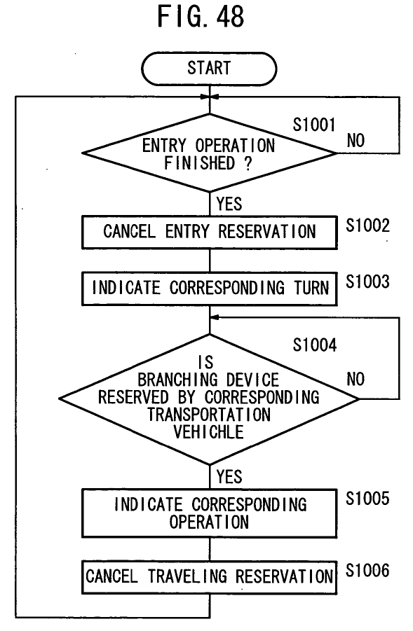

Separate from the main routine, a process of moving a transportation vehicle 18 is performed in steps S1001 through S1006 (see FIG. 48). This process is performed independently of steps S901 through S906 and steps S1 through S12 in the main routine, and carried out by parallel processing in real-time according to a time-sharing process.

Steps S1001 through S1006 are provided in as many sets as the number of transportation vehicles 18.

In step S1001, the operation plan table 104 shown in FIG. 17 is referred to for confirming the present state of the corresponding transportation vehicle 18. If the operation state flag FLG in a certain place is “2” indicating an operation completion and the operation state flag FLG in a next place is “0” indicating an operation not yet started, then control goes to step S1002. If there is no such transportation vehicle 18 which has finished an entry operation, then control waits.

In step S1002, an entry reservation is canceled. Specifically, since the corresponding transportation vehicle 18 has finished its entry into a certain branching device 22, its reservation is canceled from the branching device reservation data table 120 (see, e.g., FIG. 46) and the branching device time management table 122 (see, e.g., FIG. 47).

For example, if the transportation vehicle 18a has entered into the branching device 22c, then the record “18a” in the column “PLACE 1” in the row of the branching device 22c of the branching device reservation data table 120 is deleted, and all records on its right side are moved to the left. The data in the corresponding column of the branching device time management table 122 is similarly deleted.

In step S1003, if the branching device 22 needs a turning action, then a corresponding turning instruction is transmitted via the communication function unit 30g to the unit controllers 26. If each of the unit controllers 26 confirms that the turning instruction is destined for itself from the address accompanying the turning instruction, then the unit controller 26 controls the branching device 22 to operate the transportation vehicle 18 according to the turning instruction.

In step S1004, the number of the branching device 22 as a traveling destination is confirmed in the column where the operation state flag FLG is “0” in the operation plan table 104, thereby to check whether the branching device 22 is reserved by the corresponding transportation vehicle 18 and previous reservations have been canceled or not by using the branching device reservation data table 120. For example, when the transportation vehicle 18a travels from the branching device 22b to the branching device 22c, if “18a” is recorded in the column “PLACE 1” in the row of the branching device 22c of the branching device reservation data table 120, then the transportation vehicle 18a can enter into the branching device 22c. If another number is recorded in the same column, then the transportation device 18a waits. In this manner, the transportation vehicle 18 having the first reservation is allowed to exclusively use the branching device 22 as a traveling destination. Since branching devices 22 that are present at this time have been reserved, the transportation vehicle 18 can exclusively use the transportation path 20 between the branching devices 22, and hence its moving action is guaranteed.

Individual programs for motion control in steps S1001 through S1006 are prepared for a plurality of transportation vehicles 18. However, since the branching device reservation data table 120 and the branching device time management table 122 are commonly referred to, the transportation vehicles 18 are prevented from conflicting with each other, and a plurality of transportation vehicles 18 can simultaneously operate within an allowable range of reservations.

In step S1005, a motion instruction for the corresponding transportation vehicle 18 is transmitted. The motion instruction is transmitted in the same manner as with the turning instruction in step S1003.

In step S1006, a traveling reservation of the corresponding transportation vehicle 18 is canceled. For example, if the transportation vehicle 18a has traveled from the branching device 22c to the mounting/dismounting device 24d, then since no traveling reservation for the branching device 22c is required, the record “18a” in the column “PLACE 1” in the row of the branching device 22c of the branching device reservation data table 120 is deleted, and all records on its right side are moved to the left. The data in the corresponding column of the branching device time management table 122 is similarly deleted.

After step S1006, control returns to step S1001 for monitoring the operation state flag FLG again.

According to the processing in step S11 in the main routine shown in FIG. 6, a branching device 22 records a reservation time which is used by a transportation vehicle 18, and prevents itself from being used by another transportation vehicle 18 in the reservation time. Therefore, transportation vehicles 18 are prevented from conflicting with each other at the same branching device 22.

Furthermore, inasmuch as the reservation time is recorded together with the number of the transportation vehicle 18, a motion of the transportation vehicle 18 can be determined based on that number.

The reservation time and the number of the transportation vehicle 18 are recorded for each of entry reservations and traveling reservations. Accordingly, the reservation time and the number of the transportation vehicle 18 are related to the motion of the transportation vehicle 18 at the branching device 22, and are effective for motion control.

When the transportation vehicle 18 finishes its use of the branching device 22, the record of the reservation time and the number of the transportation vehicle 18 is deleted from the branching device reservation data table 120 and the branching device time management table 122. Consequently, the latest information is recorded at all times in the branching device reservation data table 120 and the branching device time management table 122 for real-time control.

Since reservation times are determined based on traveling times, turning times, and standby times, accurate reservations can be made.

As a transportation vehicle 18 having a first reservation of reservation times is moved or turned, it can exclusively be used while reliably excluding other transportation vehicles 18. Even if the transportation vehicle 18 does not move as planned, it can be confirmed, prior to the movement, from the branching device reservation data table 120 that the branching device 22 has been reserved by the corresponding transportation vehicle 18 and previous reservations have been canceled, thereby avoiding conflicts.

According to the processing in step S11, the operation plan table 104, the branching device information table 112, the transportation path information table 113, the path candidate data table 114b, the path candidate time data table 115, the branching device reservation data table 120, and the branching device time management table 122 are referred to, compared, and updated for controlling the workpiece transportation system in real-time without the need for complex processing operations. As a result, the workpiece transportation system can handle abrupt plan changes and allows paths to be selected with high freedom.

Even when mounting/dismounting devices 24, branching devices 22, processing machines 14, etc. are added or removed, the workpiece transportation system is made applicable simply by updating certain data in the operation plan table 104, the branching device information table 112, the transportation path information table 113, the path candidate data table 114b, the path candidate time data table 115, the branching device reservation data table 120, and the branching device time management table 122 without algorithm alterations.

The branching device time management table 122 does not represent relative times from the present time, but may represent absolute times based on a reference time.

The system for and method of transporting workpieces according to the above embodiment may have various different arrangements or procedures. For example, a plurality of charging devices 36 and a plurality of discharging devices 38 may be installed. The transportation paths 20 may not be straight paths, but may be replaced with straight paths interconnecting opposite ends thereof. The transportation paths 20 may not extend perpendicularly to each other. Since any number of connection destinations for the branching devices 22 may be employed, it is possible to change the transportation paths 20 to various forms.

The transportation vehicles 18 are not limited to the externally propelled type which is driven by the wires 60, but may be of the self-propelled type or self-standing type which moves on the floor. The transportation paths are expressed by the strings of the numbers of branching devices 22 that are present on the paths. However, they may be expressed by the strings of the numbers of transportation paths 20.

The network of transportation paths is applicable to not only a two-dimensional pattern, but also a three-dimensional warehouse or the like. The transportation paths 20 may have portions crossing each other three-dimensionally with no branching devices 22 interposed therebetween. The network of transportation paths may be an urban traffic network or the like.

The method of and system for transporting workpieces according to the present invention are not limited to the above embodiment, but may incorporate various arrangements without departing from the scope of the invention.

1. A method of transporting workpieces using:
a plurality of transportation units for transporting workpieces;
a plurality of stations into which said workpieces can be loaded from said transportation units and from which said workpieces can be unloaded to said transportation units;
a plurality of transportation paths for moving said transportation units therealong and stopping said transportation units thereon;
relay paths disposed at relay points between two or more of said transportation paths, for receiving said transportation units which have entered and stopped from one of said transportation paths and sending said transportation units to enter into another one of said transportation paths and
a control unit for controlling operation of said transportation units, said transportation paths, said stations, and said relay paths;
said method comprising the first, second, third, and fourth steps of:
determining areas assigned to said transportation units, respectively;
determining a loading source and an unloading source for each of said transportation units;
enumerating path candidates determined by searching for transportation paths for each of said transportation units; and
calculating transportation times for the path candidates, respectively, and selecting a path having the shortest transportation time based on operating conditions of the transportation units;
wherein said workpieces are loaded into and unloaded from said stations by said transportation units.

2. A method of transporting workpieces according to claim 1, further comprising the steps of:
determining a frequency with which to load said workpieces into and unload said workpieces from each of said stations; and
dividing said stations into a plurality of areas so that the sums of the frequencies are in substantial conformity with each other, and assigning a constant number of said transportation units to each of said areas;
wherein each of said transportation units loads said workpieces into and unloads said workpieces from said stations in the area assigned to said transportation units.

3. A method of transporting workpieces according to claim 1, wherein said first step comprises the steps of:
determining a frequency with which to load said workpieces into and unload said workpieces from each of said stations;
dividing said stations into a plurality of basic areas so that the sums of the frequencies are in substantial conformity with each other, assigning one of said transportation units to each of said basic areas, and storing information of said basic areas;
assuming that one of said transportation units cannot be used, providing a combined area including the basic area assigned to the unusable transportation unit and basic areas adjacent to said basic area, dividing said stations in said combined area into provisional areas so that the sums of the frequencies are in substantial conformity with each other, assigning one of said transportation units to each of said provisional areas, and storing information of said provisional areas;
loading said workpieces into and unloading said workpieces from said stations in said basic areas to which said transportation units are assigned, while detecting states of said transportation units; and
when one of said transportation units cannot be used, replacing a combined area preset for the unusable transportation unit with said provisional area.

4. A method of transporting workpieces according to claim 2, wherein said step of determining a frequency comprises the step of determining an actual frequency with which to load or unload said workpieces, including a standby time in which said station waits for processing.

5. A method of transporting workpieces according to claim 2, wherein said stations serve to process said workpieces and are classified into a plurality of processes in order, said step of determining a frequency comprises the step of determining the frequency from a process assigning ratio in said processes.

6. A method of transporting workpieces according to claim 2, wherein said stations serve to process said workpieces and are classified into a plurality of processes in order, said method further comprising the steps of:
determining one of said processes which has a slowest average workpiece processing time; and
temporarily executing said transportation units and said stations and checking an operating efficiency of said determined process having the slowest average workpiece processing time;
wherein if said operating efficiency is not 100%, conditions are changed, and said step of dividing said stations into a plurality of areas so that the sums of the frequencies are in substantial conformity with each other, and assigning a constant number of said transportation units to each of said areas is carried out again.

7. A method of transporting workpieces according to claim 3, wherein said provisional areas are changed back to said basic areas when said unusable transportation unit is restored so as to be usable.

8. A method of transporting workpieces according to claim 1, wherein said second step comprises the steps of:
storing a loading request signal from said stations;
storing an unloading request signal from said stations; and
updating an operation plan of said transportation units based on said loading request signal and said unloading request signal.

9. A method of transporting workpieces according to claim 8, wherein said step of updating an operation plan is executed when said control unit receives said loading request signal or said unloading request signal, or one of said transportation units becomes idle.

10. A method of transporting workpieces according to claim 8, wherein said step of storing a loading request signal and said step of storing an unloading request signal store said loading request signal and said unloading request signal in a chronological sequence.

11. A method of transporting workpieces according to claim 8, further comprising the step of:
assigning said transportation units which load or unload said workpieces to said stations;
wherein said step of updating an operation plan is executed when a transportation unit assigned to a station which has sent said loading request signal is determined and said determined transportation unit is judged as being idle from said operation plan.

12. A method of transporting workpieces according to claim 1, further comprising the steps of:
when said transportation units are transported along the path selected in said fourth step, recording reservation information for each of said transportation paths or said relay paths, indicating that said transportation units use said transportation path or said relay path; and
preventing the transportation path or said relay path for which said reservation information is recorded, from being used by other transportation units based on contents of said reservation information.

13. A method of transporting workpieces according to claim 12, wherein said reservation information includes place information and time information representing, respectively, the places in order and times of the transportation units which use said transportation path or said relay path.

14. A method of transporting workpieces according to claim 12, wherein said reservation information is recorded as being divided into an entry reservation for the transportation units to enter into said transportation path or said relay path, and a traveling reservation for the transportation units to leave said transportation path or said relay path.

15. A method of transporting workpieces according to claim 12, wherein the record of said reservation information is deleted when the transportation units end using said transportation path or said relay path for which said reservation information has been recorded.

16. A method of transporting workpieces according to claim 1, wherein said third step comprises the steps of:
stipulating a reference vector (V₀) extending from a start point to a goal point on a network of transportation paths and relay paths to which the transportation paths are connected; and
selecting one of the transportation paths which is present in a predetermined angular range from said reference vector (V₀) and includes said start point, as a movement path.

17. A method of transporting workpieces according to claim 16, wherein in said step of selecting one of the transportation paths which is present in a predetermined angular range from said reference vector (V₀) and includes said start point, as a movement path, if no transportation path is present within said predetermined angular range, then a transportation path having a smallest angle with respect to said reference vector (V₀) is selected as a movement path.

18. A method of transporting workpieces according to claim 16, further comprising the steps of:
stipulating one of the relay paths remoter from said start point, as a next start point, the relay paths being connected to the transportation path selected as the movement path, and stipulating a reference vector (V₀) extending from a start point to a goal point on a network of transportation paths and relay paths to which the transportation paths are connected;
selecting one of the transportation paths which is present in a predetermined angular range from said reference vector (V₀) and includes said start point, as a movement path; and
repeating said steps of stipulating one of the relay paths and selecting one of the transportation paths.

19. A method of transporting workpieces according to claim 16, wherein if said start point or said goal point is a midway point on said transportation path, then said start point or said goal point is replaced with a relay path connected to said transportation path.

20. A method of transporting workpieces according to claim 1, wherein said third step comprises the steps of:
storing a path candidate from a start point to a goal point as a string of relay paths on a network of paths;
selecting one of the relay paths stored as said path candidate, as a selected relay path;
stipulating a reference vector (V₀) extending from said start point to said selected relay path;
searching for a transportation path which is present in a predetermined angular range from said reference vector (V₀) and includes said start point, as a corrective transportation path;
establishing a partial corrective path leading to said selected relay path, with a relay path connected to said corrective transportation path being established next to said start point; and
storing a path including said partial corrective path in part or entirety and leading to said goal point, as a corrective path.

21. A method of transporting workpieces according to claim 20, wherein said step of storing a corrective path stores a path having a portion of said path candidate which extends from said. selected relay path to said goal point and is added to a latter part of said partial corrective path in part or entirety, as the corrective path.

22. A method of transporting workpieces according to claim 20, wherein when a plurality of path candidates are stored, a path candidate with said selected relay path being stored in a smallest place in order or a path candidate having a shortest length is selected as a selected path candidate, and said step of storing a path including said partial corrective path in part or entirety and leading to said goal point, as a corrective path, is carried out only when the place in order of said selected relay path in said selected path candidate is greater than the place in order of said selected relay path in said partial corrective path.

23. A method of transporting workpieces according to claim 1, wherein said fourth step comprises the steps of:
storing a path extending from a start point to a goal point on a network of transportation paths and relay paths to which the transportation paths are connected, as a string of said transportation paths and/or said relay paths, and determining a passage time required for said transportation units to pass through said transportation paths and said relay paths;
determining a standby time in which said transportation units wait on said transportation paths and said relay paths; and
totaling said passage time and said standby time to calculate a transportation time over said path.

24. A method of transporting workpieces according to claim 23, wherein a reservation time for each of transportation paths and/or said relay paths and an arrival time at which said transportation units arrive at said transportation paths and/or said relay paths are compared with each other, and if said reservation time is greater than said arrival time, the difference therebetween is used as said standby time, and if said reservation time is smaller than said arrival time, said standby time is set to 0.

25. A system for transporting workpieces, comprising:
a plurality of transportation units for transporting workpieces;
a plurality of transportation paths for moving said transportation units therealong and stopping said transportation units thereon;
a plurality of stations into which said workpieces can be loaded from said transportation units and from which said workpieces can be unloaded to said transportation units;
relay paths disposed at relay points between two or more of said transportation paths, for receiving said transportation units which have entered and stopped from one of said transportation paths and sending said transportation units to enter into another one of said transportation paths and
a control unit for controlling operation of said transportation units, said transportation paths, said stations, and said relay paths
wherein said control unit assigns a constant number of said transportation units to a plurality of areas which are established so that the sums of frequencies with which to load or unload said workpieces are in substantial conformity with each other.

26. A system for transporting workpieces according to claim 25, further comprising:
a request memory unit for storing a loading request signal from said stations and an unloading request signal from said stations; and
an operation plan updating unit for updating operation plans of said transportation units based on said loading request signal and said unloading request signal.

27. A system for transporting workpieces according to claim 25, wherein said control unit records reservation information for each of said transportation paths or said relay paths, indicating that said transportation units use said transportation path or said relay path, and prevents the transportation path or said relay path for which said reservation information is recorded, from being used by other transportation units based on contents of said reservation information.

28. A system for transporting workpieces according to claim 25, further comprising:
a vector stipulating unit for stipulating a reference vector from a start point to an end point on a network of said transportation paths and said relay paths; and
an angular range path selecting unit for selecting one of the transportation paths which is present in a predetermined angular range from said reference vector (V₀) and includes said start point, as a movement path.

29. A system for transporting workpieces according to claim 25, further comprising:
a passage time calculating unit for storing a path extending from a start point to a goal point on a network of said transportation paths and said relay paths, as a string of said transportation paths and/or said relay paths, and determining a passage time required for said transportation units to pass through said transportation paths and said relay paths;
a standby time calculating unit for determining a standby time in which said transportation units wait on said transportation paths and said relay paths; and
a transportation time totaling unit for totaling said passage time and said standby time for the string of said transportation paths and/or said relay paths, to calculate a transportation time over said path.
